(19) United States
(12) Patent Application Publication
(10) Pub. No.: US 2021/0387120 A1
(43) Pub. Date: Dec. 16, 2021

(54) FILTER MEDIA COMPRISING FIBRILLATED FIBERS AND GLASS FIBERS

(71) Applicant: Hollingsworth & Vose Company, East Walpole, MA (US)

(72) Inventors: Thomas Petri, Breidenbach (DE); Sudhakar Jaganathan, Northborough, MA (US)

(73) Assignee: Hollingsworth & Vose Company, East Walpole, MA (US)

(21) Appl. No.: 16/899,884

(22) Filed: Jun. 12, 2020

(51) Int. Cl. B01D 39/16; B01D 39/18; B01D 39/20

(52) U.S. Cl. CPC B01D 39/163; B01D 2239/065; B01D 39/2017; B01D 39/18

(57) ABSTRACT

Filter media comprising fibrillated fibers and glass fibers are generally described.

### TECHNICAL FIELD

Filter media comprising fibrillated fibers and glass fibers are generally described.

### BACKGROUND

Filter media are articles that can be used to remove contamination in a variety of applications. In general, filter media can be formed of a web (e.g., non-woven) of fibers. The fiber web provides a porous structure that permits fluid (e.g., hydraulic fluid, fuel, oil, and/or air) to flow through the filter media. Contaminant particles contained within the fluid may be trapped on the fibrous web. Filter media and fiber characteristics may be selected to affect filtration performance (e.g., efficiency, dust holding capacity, air permeability, etc.) as well as mechanical performance (e.g., stiffness, Mullen burst strength, etc.).

### SUMMARY

Filter media comprising fibrillated fibers and glass fibers are generally described.

In some aspects, filter media are described. In some embodiments, the filter media comprises a multi-phase layer, wherein the multi-phase layer comprises a first phase and a second phase, wherein the first phase comprises fibrillated fibers and greater than or equal to 25 wt % glass fibers, wherein the second phase comprises cellulose fibers and/or synthetic fibers, and wherein at least a portion of the fibers of the first phase are intermingled with at least a portion of the fibers of the second phase at an interface of the first phase and the second phase.

In some embodiments, the filter media comprises a first phase comprising fibrillated fibers and glass fibers; wherein the first phase comprises greater than or equal to 25 wt % and less than or equal to 80 wt % glass fibers; and wherein the filter media has a dry Mullen burst strength of greater than 50 kPa and less than or equal to 2,000 kPa.

In some embodiments, the filter media comprises a first phase comprising fibrillated fibers and glass fibers; wherein the first phase comprises greater than or equal to 25 wt % and less than or equal to 80 wt % glass fibers; and wherein the first phase has a dry Mullen burst strength of greater than 50 kPa and less than or equal to 250 kPa.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows, in accordance with some embodiments, a filter media comprising a phase (e.g., a first phase or a second phase).

FIG. 2A show, in accordance with some embodiments, a filter media comprising a multi-phase layer (e.g., a dual phase layer).

FIG. 2B shows, in accordance with some embodiments, a filter media comprising a multi-phase layer (e.g., a dual phase layer).

FIG. 3 shows, in accordance with some embodiments, a filter media comprising a multi-phase layer (e.g., a dual phase layer) and an additional layer.

FIG. 4 shows an SEM image of a filter media comprising a dual phase layer, in accordance with some embodiments, at 75× magnification (FIG. 4A), 175× magnification (FIG. 4B), and 350× magnification (FIG. 4C).

FIG. 5 shows a plot of dry Mullen burst strength of various cured filter media versus the pressure used in the wet end compression process.

FIG. 6 shows a plot of z-directional bonding strength between the first phase and the additional layer of filter media for various first phase compositions.

### DETAILED DESCRIPTION

Filter media comprising fibrillated fibers and glass fibers are generally described. In some embodiments, the filter media comprises a first phase comprising fibrillated fibers (e.g., Lyocell fibers) and glass fibers (e.g., microglass fibers). The inclusion of the first phase may, for example, increase the efficiency of the filter media. In some embodiments, the filter media comprises a second phase. In some embodiments, the second phase comprises cellulose fibers and/or synthetic fibers. In some cases, inclusion of the second phase increases the stiffness and/or pleatability of the filter media. In some embodiments, the filter media comprises a multi-phase layer (e.g., a dual phase layer) comprising the first phase and the second phase.

In some embodiments, the multi-phase layer (e.g., the dual phase layer) is wetlaid. In some embodiments, at least a portion of the fibers of the first phase are intermingled with at least a portion of the fibers of the second phase at an interface of the first phase and the second phase. In some embodiments, the multi-phase layer (e.g., the dual phase layer) comprises a gradient in the amount of one or more types of fibers (e.g., glass fibers and/or fibrillated fibers). In some embodiments, the intermingling of the fibers and/or the gradient in the amount of one or more types of fibers results in increased strength and increased dust holding capacity of the multi-phase layer (e.g., the dual phase layer) and/or filter media.

In some embodiments, the multi-phase layer (e.g., the dual phase layer) is formed in part by a process comprising wet end compression. This method of forming the multi-phase layer (e.g., the dual phase layer) may result in the layer or media having an increased dry Mullen burst strength. The amount of pressure used in the wet end compression process may be varied and/or balanced to achieve desired characteristics. For instance, if the amount of pressure used in wet end compression is too low, the efficiency of the multi-phase layer (e.g., the dual phase layer) and/or filter media may be reduced. If the amount of pressure used in wet end compression is too high, the dust holding capacity may be reduced.

In some embodiments, the filter media comprises an additional layer (e.g., a meltblown layer). For instance, the filter media may include a multi-phase layer (e.g., a dual phase layer) as described herein combined with the additional layer. In some embodiments, inclusion of the additional layer increases the dust holding capacity of the filter media. In some embodiments, the additional layer is connected to the multi-phase layer (e.g., the dual phase layer) and/or the first phase, e.g., by thermo-dot bonding, without adhesive. In some instances, thermo-dot bonding without adhesive may have advantages compared to bonding using adhesive, such as reduced shedding of fibers, reduced downtime of the machine, reduced waste of material, reduced expense, and/or reduced risk of pore blockage.

In some embodiments, the z-directional bonding strength (e.g., the z-directional bonding strength that can be achieved with thermo-dot bonding without adhesive) is affected by the percentage of fibrillated fibers in the first phase. For example, in some embodiments, the z-directional bonding strength between the additional layer and the multi-phase layer (e.g., the dual phase layer) and/or between the additional layer and the first phase after thermo-dot bonding without adhesive is higher for a filter media disclosed herein than for a similar filter media with lower amounts or no fibrillated fibers, all other factors being equal.

Similarly, in some embodiments, the dry Mullen burst strength of the first phase and/or the filter media is affected by the percentage of fibrillated fibers in the first phase. For example, in some embodiments, the dry Mullen burst strength of the first phase and/or the filter media is higher for embodiments disclosed herein than for a similar embodiment with lower amounts or no fibrillated fibers, all other factors being equal. Similarly, in some embodiments, the dry Mullen burst strength of the first phase and/or the filter media is affected by the percentage of glass fibers in the first phase. For example, in some embodiments, the dry Mullen burst strength of the first phase and/or the filter media is higher for embodiments disclosed herein than for a similar embodiment with higher amounts of glass fibers, all other factors being equal.

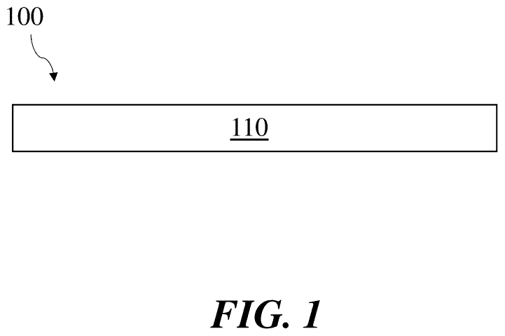

Certain aspects are related to filter media. Non-limiting examples of such filter media are shown in FIGS. 1-3. In some embodiments, the filter media comprises a first phase. For example, in some embodiments, a filter media 100 of FIG. 1 comprises a phase 110 (e.g., a first phase). In some embodiments, the phase is wetlaid (e.g., formed by a wet laying process). In some embodiments, the first phase comprises fibrillated fibers and/or glass fibers. In some embodiments, the first phase comprises fibrillated fibers and glass fibers. In some embodiments, the fibrillated fibers comprise lyocell fibers. In some embodiments, the glass fibers comprise microglass fibers and/or chopped strand glass fibers.

One skilled in the art is able to determine whether a glass fiber is chopped strand or microglass by observation (e.g., optical microscopy, electron microscopy). Chopped strand glass may also have chemical differences from microglass fibers. In some cases, though not required, chopped strand glass fibers may contain a greater content of calcium or sodium than microglass fibers. For example, chopped strand glass fibers may be close to alkali free with high calcium oxide and alumina content. Microglass fibers may contain 10-15% alkali (e.g., sodium, magnesium oxides) and have relatively lower melting and processing temperatures. The terms refer to the technique(s) used to manufacture the glass fibers. Such techniques impart the glass fibers with certain characteristics. In general, chopped strand glass fibers are drawn from bushing tips and cut into fibers. Microglass fibers are drawn from bushing tips and further subjected to flame blowing or rotary spinning processes. In some cases, fine microglass fibers may be made using a remelting process. In this respect, microglass fibers may be fine or coarse. Chopped strand glass fibers are produced in a more controlled manner than microglass fibers, and as a result, chopped strand glass fibers will generally have less variation in fiber diameter and length than microglass fibers.

The first phase may have any suitable amount of fibrillated fibers. In some embodiments, the first phase comprises greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 50 wt %, greater than or equal to 60 wt %, greater than or equal to 70 wt %, or greater than or equal to 80 wt % fibrillated fibers compared to the total fiber content of the first phase. In some embodiments, the first phase comprises less than or equal to 90 wt %, less than or equal to 85 wt %, less than or equal to 80 wt %, less than or equal to 75 wt %, less than or equal to 70 wt %, less than or equal to 60 wt %, less than or equal to 50 wt %, less than or equal to 40 wt %, less than or equal to 30 wt %, or less than or equal to 20 wt % fibrillated fibers compared to the total fiber content of the first phase. Combinations of these ranges are also possible (e.g., greater than or equal to 10 wt % and less than or equal to 90 wt %, greater than or equal to 20 wt % and less than or equal to 80 wt %, or greater than or equal to 40 wt % and less than or equal to 70 wt % fibrillated fibers compared to the total fiber content of the first phase).

The first phase may have any suitable amount of glass fibers. In some embodiments, the first phase comprises greater than or equal to 25 wt %, greater than or equal to 30 wt %, greater than or equal to 35 wt %, greater than or equal to 40 wt %, greater than or equal to 45 wt % greater than or equal to 50 wt %, greater than or equal to 60 wt %, or greater than or equal to 70 wt % glass fibers compared to the total fiber content of the first phase. In some embodiments, the first phase comprises less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 40 wt %, or less than or equal to 30 wt % glass fibers compared to the total fiber content of the first phase. Combinations of these ranges are also possible (e.g., greater than or equal to 25 wt % and less than or equal to 80 wt %, greater than or equal to 30 wt % and less than or equal to 60 wt %, or greater than or equal to 30 wt % and less than or equal to 50 wt % glass fibers compared to the total fiber content of the first phase).

In some embodiments, the first phase comprises greater than or equal to 10 wt % and less than or equal to 90 wt % fibrillated fibers and greater than or equal to 25 wt % and less than or equal to 80 wt % glass fibers compared to the total fiber content of the first phase. In some embodiments, the first phase comprises greater than or equal to 20 wt % and less than or equal to 80 wt % fibrillated fibers and greater than or equal to 30 wt % and less than or equal to 60 wt % glass fibers compared to the total fiber content of the first phase. In some embodiments, the first phase comprises greater than or equal to 40 wt % and less than or equal to 70 wt % fibrillated fibers and greater than or equal to 30 wt % and less than or equal to 50 wt % glass fibers compared to the total fiber content of the first phase.

In embodiments in which fibrillated fibers are present (e.g., in the first phase), the fibrillated fibers may have any suitable average diameter. A fibrillated fiber includes a parent fiber that branches into smaller diameter fibrils which can, in some instances, branch further out into even smaller diameter fibrils with further branching also being possible. As used herein, the average diameter of the parent fiber is considered to be the average diameter of the fibrillated fiber, unless indicated otherwise.

The parent fiber may have any suitable average diameter. In some embodiments, the average diameter of the parent fibers is less than or equal to 75 microns, less than or equal to 60 microns, less than or equal to 50 microns, less than or equal to 40 microns, less than or equal to 30 microns, less than or equal to 20 microns, or less than or equal to 15 microns. In some embodiments the average diameter of the parent fibers is greater than or equal to 10 microns, greater than or equal to 15 microns, greater than or equal to 20 microns, greater than or equal to 30 microns, greater than or equal to 40 microns, greater than or equal to 50 microns, greater than or equal to 60 microns, or greater than or equal to 75 microns. Combinations of the above referenced ranges are also possible (e.g., greater than or equal to 10 microns and less than 75 microns).

The fibrils may have any suitable average diameter. In some embodiments, the average diameter of the fibrils is less than or equal to 15 microns, less than or equal to 10 microns, less than or equal to 8 microns, less than or equal to 6 microns, less than or equal to 4 microns, less than or equal to 3 microns, less than or equal to 2 microns, less than or equal to 1 micron, or less than or equal to 0.5 microns. In some embodiments the average diameter of the fibrils is greater than or equal to 0.08 microns, greater than or equal to 0.1 microns, greater than or equal to 0.2 microns, greater than or equal to 0.5 microns, greater than or equal to 1 micron, greater than or equal to 2 microns, greater than or equal to 3 microns, greater than or equal to 4 microns, greater than or equal to 6 microns, greater than or equal to 8 microns, or greater than or equal to 10 microns. Combinations of the above referenced ranges are also possible (e.g., greater than or equal to 3 microns and less than 6 microns).

The fibrillated fibers may have any suitable average length. In some embodiments, the average length of the fibrillated fibers is greater than or equal to 0.3 millimeters, greater than or equal to 0.5 millimeters, greater than or equal to 1 millimeter, greater than or equal to 1.1 millimeters, greater than or equal to 1.2 millimeters, greater than or equal to 1.3 millimeters, greater than or equal to 1.4 millimeters, greater than or equal to 1.5 millimeters, greater than or equal to 1.6 millimeters, greater than or equal to 1.7 millimeters, greater than or equal to 1.8 millimeters, greater than or equal to 1.9 millimeters, greater than or equal to 2 millimeters, greater than or equal to 3 millimeters, greater than or equal to 4 millimeters, or greater than or equal to 5 millimeters. In some embodiments, the average length of the fibrillated fibers is less than or equal to 6 millimeters, less than or equal to 5.75 millimeters, less than or equal to 5.5 millimeters, less than or equal to 5.25 millimeters, less than or equal to 5 millimeters, less than or equal to 4.75 millimeters, less than or equal to 4.5 millimeters, less than or equal to 4.25 millimeters, less than or equal to 4 millimeters, less than or equal to 3 millimeters, less than or equal to 2 millimeters, less than or equal to 1.5 millimeters, less than or equal to 1.4 millimeters, less than or equal to 1.3 millimeters, less than or equal to 1.2 millimeters, less than or equal to 1.1 millimeters, or less than or equal to 1 millimeter. Combinations of these ranges are also possible (e.g., greater than or equal to 0.3 millimeters and less than or equal to 6 millimeters, greater than or equal to 1.5 millimeters and less than or equal to 5 millimeters, or greater than or equal to 2 millimeters and less than or equal to 4 millimeters).

The level of fibrillation of the fibrillated fibers may be measured according to any number of suitable methods. For example, the level of fibrillation of the fibrillated fibers can be measured according to a Canadian Standard Freeness (CSF) test, specified by TAPPI test method T 227 om 09 Freeness of pulp. The test can provide an average CSF value. The fibrillated fibers may have any suitable average CSF. In some embodiments, the average CSF of the fibrillated fibers is greater than or equal to 10 CSF, greater than or equal to 25 CSF, greater than or equal to 50 CSF, greater than or equal to 75 CSF, greater than or equal to 100 CSF, greater than or equal to 120 CSF, greater than or equal to 140 CSF, greater than or equal to 150 CSF, greater than or equal to 160 CSF, greater than or equal to 180 CSF, greater than or equal to 200 CSF, greater than or equal to 300 CSF, greater than or equal to 400 CSF, greater than or equal to 500 CSF, greater than or equal to 600 CSF, or greater than or equal to 700 CSF. In some embodiments, the average CSF of the fibrillated fibers is less than or equal to 850 CSF, less than or equal to 800 CSF, less than or equal to 750 CSF, less than or equal to 700 CSF, less than or equal to 650 CSF, less than or equal to 600 CSF, less than or equal to 550 CSF, less than or equal to 500 CSF, less than or equal to 450 CSF, less than or equal to 400 CSF, less than or equal to 300 CSF, less than or equal to 200 CSF, less than or equal to 150 CSF, less than or equal to 100 CSF, less than or equal to 75 CSF, or less than or equal to 50 CSF. Combinations of these ranges are also possible (e.g., greater than or equal to 10 CSF and less than or equal to 850 CSF, greater than or equal to 150 CSF and less than or equal to 500 CSF, or greater than or equal to 200 CSF and less than or equal to 400 CSF).

In embodiments in which glass fibers are present (e.g., in the first phase), the glass fibers may have any suitable average diameter. In some embodiments, the average diameter of the glass fibers is greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, the average diameter of the glass fibers is less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1 micron, less than or equal to 0.95 microns, less than or equal to 0.9 microns, less than or equal to 0.85 microns, less than or equal to 0.8 microns, less than or equal to 0.75 microns, less than or equal to 0.7 microns, less than or equal to 0.65 microns, less than or equal to 0.6 microns, less than or equal to 0.5 microns, less than or equal to 0.4 microns, or less than or equal to 0.3 microns. Combinations of these ranges are also possible (e.g., greater than or equal to 0.2 microns and less than or equal to 50 microns, greater than or equal to 5 microns and less than or equal to 50 microns, greater than or equal to 5 microns and less than or equal to 20 microns, greater than or equal to 5 microns and less than or equal to 10 microns, greater than or equal to 0.2 microns and less than or equal to 1 micron, greater than or equal to 0.2 microns and less than or equal to 0.8 microns, or greater than or equal to 0.2 microns and less than or equal to 0.6 microns).

The glass fibers may have any suitable average length. In some embodiments, the average length of the glass fibers is greater than or equal to 0.075 millimeters, greater than or equal to 0.1 millimeters, greater than or equal to 0.2 millimeters, greater than or equal to 0.3 millimeters, greater than or equal to 0.4 millimeters, greater than or equal to 0.5 millimeters, greater than or equal to 0.6 millimeters, greater than or equal to 0.7 millimeters, greater than or equal to 0.8 millimeters, greater than or equal to 0.9 millimeters, greater than or equal to 1 millimeter, greater than or equal to 1.25 millimeters, greater than or equal to 1.5 millimeters, greater than or equal to 1.75 millimeters, greater than or equal to 2 millimeters, greater than or equal to 3 millimeters, greater than or equal to 4 millimeters, greater than or equal to 5 millimeters, greater than or equal to 6 millimeters, greater than or equal to 7 millimeters, greater than or equal to 8 millimeters, greater than or equal to 9 millimeters, greater than or equal to 10 millimeters, greater than or equal to 12 millimeters, greater than or equal to 14 millimeters, greater than or equal to 16 millimeters, or greater than or equal to 18 millimeters. In some embodiments, the average length of the glass fibers is less than or equal to 20 millimeters, less than or equal to 18 millimeters, less than or equal to 16 millimeters, less than or equal to 14 millimeters, less than or equal to 12 millimeters, less than or equal to 10 millimeters, less than or equal to 9 millimeters, less than or equal to 8 millimeters, less than or equal to 7 millimeters, less than or equal to 6 millimeters, less than or equal to 5 millimeters, less than or equal to 4 millimeters, less than or equal to 3 millimeters, less than or equal to 2.75 millimeters, less than or equal to 2.5 millimeters, less than or equal to 2.25 millimeters, less than or equal to 2 millimeters, less than or equal to 1.75 millimeters, less than or equal to 1.5 millimeters, less than or equal to 1.25 millimeters, less than or equal to 1 millimeter, less than or equal to 0.9 millimeters, less than or equal to 0.8 millimeters, less than or equal to 0.7 millimeters, less than or equal to 0.6 millimeters, less than or equal to 0.5 millimeters, less than or equal to 0.4 millimeters, or less than or equal to 0.3 millimeters. Combinations of these ranges are also possible (e.g., greater than or equal to 0.075 millimeters and less than or equal to 20 millimeters, greater than or equal to 3 millimeters and less than or equal to 20 millimeters, greater than or equal to 6 millimeters and less than or equal to 12 millimeters, greater than or equal to 0.5 millimeters and less than or equal to 3 millimeters, greater than or equal to 0.5 millimeters and less than or equal to 2 millimeters, or greater than or equal to 0.5 millimeters and less than or equal to 1.5 millimeters).

In embodiments in which microglass fibers are present (e.g., in the first phase), the microglass fibers may have any suitable average diameter. In some embodiments, the average diameter of the microglass fibers is greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, or greater than or equal to 0.9 microns. In some embodiments, the average diameter of the microglass fibers is less than or equal to 1 micron, less than or equal to 0.95 microns, less than or equal to 0.9 microns, less than or equal to 0.85 microns, less than or equal to 0.8 microns, less than or equal to 0.75 microns, less than or equal to 0.7 microns, less than or equal to 0.65 microns, less than or equal to 0.6 microns, less than or equal to 0.5 microns, less than or equal to 0.4 microns, or less than or equal to 0.3 microns. Combinations of these ranges are also possible (e.g., greater than or equal to 0.2 microns and less than or equal to 1 micron, greater than or equal to 0.2 microns and less than or equal to 0.8 microns, or greater than or equal to 0.2 microns and less than or equal to 0.6 microns).

The microglass fibers may have any suitable average length. In some embodiments, the average length of the microglass fibers is greater than or equal to 0.075 millimeters, greater than or equal to 0.1 millimeters, greater than or equal to 0.2 millimeters, greater than or equal to 0.3 millimeters, greater than or equal to 0.4 millimeters, greater than or equal to 0.5 millimeters, greater than or equal to 0.6 millimeters, greater than or equal to 0.7 millimeters, greater than or equal to 0.8 millimeters, greater than or equal to 0.9 millimeters, greater than or equal to 1 millimeter, greater than or equal to 1.25 millimeters, greater than or equal to 1.5 millimeters, greater than or equal to 1.75 millimeters, or greater than or equal to 2 millimeters. In some embodiments, the average length of the microglass fibers is less than or equal to 3 millimeters, less than or equal to 2.75 millimeters, less than or equal to 2.5 millimeters, less than or equal to 2.25 millimeters, less than or equal to 2 millimeters, less than or equal to 1.75 millimeters, less than or equal to 1.5 millimeters, less than or equal to 1.25 millimeters, less than or equal to 1 millimeter, less than or equal to 0.9 millimeters, less than or equal to 0.8 millimeters, less than or equal to 0.7 millimeters, less than or equal to 0.6 millimeters, less than or equal to 0.5 millimeters, less than or equal to 0.4 millimeters, or less than or equal to 0.3 millimeters. Combinations of these ranges are also possible (e.g., greater than or equal to 0.075 millimeters and less than or equal to 3 millimeters, greater than or equal to 0.5 millimeters and less than or equal to 2 millimeters, or greater than or equal to 0.5 millimeters and less than or equal to 1.5 millimeters).

In embodiments in which chopped strand glass fibers are present (e.g., in the first phase), the chopped strand glass fibers may have any suitable average diameter. In some embodiments, the average diameter of the chopped strand glass fibers is greater than or equal to 5 microns, greater than or equal to 6 microns, greater than or equal to 7 microns, greater than or equal to 8 microns, greater than or equal to 9 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, the average diameter of the chopped strand glass fibers is less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 9 microns, less than or equal to 8 microns, less than or equal to 7 microns, or less than or equal to 6 microns. Combinations of these ranges are also possible (e.g., greater than or equal to 5 microns and less than or equal to 50 microns, greater than or equal to 5 microns and less than or equal to 20 microns, or greater than or equal to 5 microns and less than or equal to 10 microns).

The chopped strand glass fibers may have any suitable average length. In some embodiments, the average length of the chopped strand glass fibers is greater than or equal to 3 millimeters, greater than or equal to 4 millimeters, greater than or equal to 5 millimeters, greater than or equal to 6 millimeters, greater than or equal to 7 millimeters, greater than or equal to 8 millimeters, greater than or equal to 9 millimeters, greater than or equal to 10 millimeters, greater than or equal to 12 millimeters, greater than or equal to 14 millimeters, greater than or equal to 16 millimeters, or greater than or equal to 18 millimeters. In some embodiments, the average length of the chopped strand glass fibers is less than or equal to 20 millimeters, less than or equal to 18 millimeters, less than or equal to 16 millimeters, less than or equal to 14 millimeters, less than or equal to 12 millimeters, less than or equal to 10 millimeters, less than or equal to 9 millimeters, less than or equal to 8 millimeters, less than or equal to 7 millimeters, less than or equal to 6 millimeters, less than or equal to 5 millimeters, or less than or equal to 4 millimeters. Combinations of these ranges are also possible (e.g., greater than or equal to 3 millimeters and less than or equal to 20 millimeters or greater than or equal to 6 millimeters and less than or equal to 12 millimeters). Regardless of the type of fibers(s) is the first phase, the fibers of the first phase may have any suitable average fiber diameter. In some embodiments, the average fiber diameter of the first phase is greater than or equal to 0.1 microns, greater than or equal to 0.15 microns, greater than or equal to 0.2 microns, greater than or equal to 0.3 microns, greater than or equal to 0.4 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, or greater than or equal to 70 microns. In some embodiments, the average fiber diameter of the first phase is less than or equal to 75 microns, less than or equal to 70 microns, less than or equal to 60 microns, less than or equal to 50 microns, less than or equal to 40 microns, less than or equal to 30 microns, less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, or less than or equal to 1 micron. Combinations of these ranges are also possible (e.g., greater than or equal to 0.1 microns and less than or equal to 75 microns, greater than or equal to 0.1 microns and less than or equal to 50 microns, or greater than or equal to 0.15 microns and less than or equal to 30 microns).

Regardless of the type of fibers(s) is the first phase, the fibers of the first phase may have any suitable average fiber length. In some embodiments, the first phase has an average fiber length of greater than or equal to 0.075 mm, greater than or equal to 0.1 mm, greater than or equal to 0.2 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.25 mm, greater than or equal to 1.5 mm, greater than or equal to 1.75 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, greater than or equal to 8 mm, greater than or equal to 10 mm, greater than or equal to 12 mm, greater than or equal to 14 mm, greater than or equal to 16 mm, or greater than or equal to 18 mm. In some embodiments, the first phase has an average fiber length of less than or equal to 20 mm, less than or equal to 18 mm, less than or equal to 16 mm, less than or equal to 12 mm, less than or equal to 10 mm, less than or equal to 8 mm, less than or equal to 6 mm, less than or equal to 5.5 mm, less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, less than or equal to 1.75 mm, less than or equal to 1.5 mm, less than or equal to 1.25 mm, less than or equal to 1 mm, less than or equal to 0.9 mm, less than or equal to 0.8 mm, less than or equal to 0.7 mm, less than or equal to 0.6 mm, less than or equal to 0.5 mm, less than or equal to 0.4 mm, or less than or equal to 0.3 mm. Combinations of these ranges are also possible (e.g., greater than or equal to 0.075 mm and less than or equal to 20 mm, greater than or equal to 0.5 mm and less than or equal to 6 mm, or greater than or equal to 0.5 mm and less than or equal to 4 mm).

The first phase may have any suitable basis weight. In some embodiments, the first phase has a basis weight of greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 125 gsm, greater than or equal to 150 gsm, or greater than or equal to 175 gsm. In some embodiments, the first phase has a basis weight of less than or equal to 200 gsm, less than or equal to 190 gsm, less than or equal to 180 gsm, less than or equal to 170 gsm, less than or equal to 160 gsm, less than or equal to 150 gsm, less than or equal to 140 gsm, less than or equal to 130 gsm, less than or equal to 120 gsm, less than or equal to 110 gsm, less than or equal to 100 gsm, less than or equal to 90 gsm, less than or equal to 80 gsm, less than or equal to 70 gsm, or less than or equal to 50 gsm. Combinations of these ranges are also possible (e.g., greater than or equal to 10 gsm and less than or equal to 200 gsm, greater than or equal to 20 gsm and less than or equal to 100 gsm, or greater than or equal to 30 gsm and less than or equal to 80 gsm). Basis weight may be measured according to DIN EN ISO 536 (2019).

The first phase may have any suitable thickness. In some embodiments, the first phase has a thickness of greater than or equal to 0.1 millimeters, greater than or equal to 0.15 millimeters, greater than or equal to 0.2 millimeters, greater than or equal to 0.25 millimeters, greater than or equal to 0.3 millimeters, greater than or equal to 0.4 millimeters, greater than or equal to 0.5 millimeters, greater than or equal to 0.6 millimeters, greater than or equal to 0.7 millimeters, greater than or equal to 0.8 millimeters, or greater than or equal to 0.9 millimeters. In some embodiments, the first phase has a thickness of less than or equal to 1 millimeter, less than or equal to 0.95 millimeters, less than or equal to 0.9 millimeters, less than or equal to 0.85 millimeters, less than or equal to 0.8 millimeters, less than or equal to 0.75 millimeters, less than or equal to 0.7 millimeters, less than or equal to 0.65 millimeters, less than or equal to 0.6 millimeters, less than or equal to 0.5 millimeters, less than or equal to 0.4 millimeters, less than or equal to 0.3 millimeters, or less than or equal to 0.2 millimeters. Combinations of these ranges are also possible (e.g., greater than or equal to 0.1 millimeters and less than or equal to 1 millimeter, greater than or equal to 0.2 millimeters and less than or equal to 0.8 millimeters, or greater than or equal to 0.3 millimeters and less than or equal to 0.6 millimeters). Thickness may be measured according to ISO 534 (2011) using a load of 1 N/cm².

The first phase may have any suitable dry Mullen burst strength. In some embodiments, the first phase has a dry Mullen burst strength of greater than 50 kPa, greater than or equal to 60 kPa, greater than or equal to 70 kPa, greater than or equal to 80 kPa, greater than or equal to 90 kPa, greater than or equal to 100 kPa, greater than or equal to 125 kPa, greater than or equal to 150 kPa, greater than or equal to 175 kPa, greater than or equal to 200 kPa, or greater than or equal to 225 kPa. In some embodiments, the first phase has a dry Mullen burst strength of less than or equal to 250 kPa, less than or equal to 240 kPa, less than or equal to 230 kPa, less than or equal to 220 kPa, less than or equal to 210 kPa, less than or equal to 200 kPa, less than or equal to 175 kPa, less than or equal to 150 kPa, less than or equal to 125 kPa, or less than or equal to 100 kPa. Combinations of these ranges are also possible (e.g., greater than 50 kPa and less than or equal to 250 kPa, greater than or equal to 80 kPa and less than or equal to 250 kPa, or greater than or equal to 100 kPa and less than or equal to 250 kPa). Dry Mullen burst strength may be measured according to EN ISO 2758 (2013).

In some embodiments, the dry Mullen burst strength of the first phase and/or the filter media is affected by the percentage of fibrillated fibers in the first phase. For example, in some embodiments, the dry Mullen burst strength of the first phase and/or the filter media is higher for embodiments disclosed herein than for a similar embodiment with lower amounts or no fibrillated fibers, all other factors being equal. Similarly, in some embodiments, the dry Mullen burst strength of the first phase and/or the filter media is affected by the percentage of glass fibers in the first phase. For example, in some embodiments, the dry Mullen burst strength of the first phase and/or the filter media is higher for embodiments disclosed herein than for a similar embodiment with higher amounts of glass fibers, all other factors being equal.

The first phase may have any suitable air permeability. In some embodiments, the air permeability of the first phase is greater than or equal to 0.1 CFM, greater than or equal to 0.2 CFM, greater than or equal to 0.3 CFM, greater than or equal to 0.4 CFM, greater than or equal to 0.5 CFM, greater than or equal to 0.6 CFM, greater than or equal to 0.7 CFM, greater than or equal to 0.8 CFM, greater than or equal to 0.9 CFM, greater than or equal to 1 CFM, greater than or equal to 2 CFM, greater than or equal to 3 CFM, greater than or equal to 4 CFM, greater than or equal to 5 CFM, greater than or equal to 10 CFM, greater than or equal to 15 CFM, greater than or equal to 20 CFM, greater than or equal to 25 CFM, greater than or equal to 30 CFM, greater than or equal to 35 CFM, greater than or equal to 40 CFM, or greater than or equal to 45 CFM. In some embodiments, the air permeability of the first phase is less than or equal to 50 CFM, less than or equal to 45 CFM, less than or equal to 40 CFM, less than or equal to 35 CFM, less than or equal to 30 CFM, less than or equal to 28 CFM, less than or equal to 25 CFM, less than or equal to 22 CFM, less than or equal to 20 CFM, less than or equal to 18 CFM, less than or equal to 15 CFM, less than or equal to 12 CFM, less than or equal to 10 CFM, less than or equal to 8 CFM, less than or equal to 5 CFM, less than or equal to 4 CFM, less than or equal to 3 CFM, or less than or equal to 2 CFM. Combinations of these ranges are also possible (e.g., greater than or equal to 0.1 CFM and less than or equal to 50 CFM, greater than or equal to 0.5 CFM and less than or equal to 20 CFM, or greater than or equal to 1 CFM and less than or equal to 10 CFM). Air permeability may be measured according to EN/ISO 9237 (1995) where the surface area is 20 cm².

The first phase may have any suitable mean flow pore size. In some embodiments, the mean flow pore size of the first phase is greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 1.1 microns, greater than or equal to 1.2 microns, greater than or equal to 1.3 microns, greater than or equal to 1.4 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 15 microns, greater than or equal to 20 microns, or greater than or equal to 25 microns. In some embodiments, the mean flow pore size of the first phase is less than or equal to 30 microns, less than or equal to 25 microns, less than or equal to 20 microns, less than or equal to 15 microns, less than or equal to 10 microns, less than or equal to 9 microns, less than or equal to 8 microns, less than or equal to 7 microns, less than or equal to 6 microns, less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.5 microns, or less than or equal to 1 micron. Combinations of these ranges are also possible (e.g., greater than or equal to 0.5 microns and less than or equal to 30 microns, greater than or equal to 0.5 microns and less than or equal to 5 microns, greater than or equal to 1 micron and less than or equal to 3 microns, or greater than or equal to 1.5 microns and less than or equal to 2.5 microns). Mean flow pore size may be measured according to ASTM E1294 (2008).

The first phase may have any suitable maximum pore size. In some embodiments, the first phase has a maximum pore size of greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, greater than or equal to 80 microns, or greater than or equal to 90 microns. In some embodiments, the first phase has a maximum pore size of less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 20 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4 microns, or less than or equal to 3 microns. Combinations of these ranges are also possible (e.g., greater than or equal to 2 microns and less than or equal to 100 microns, greater than or equal to 3 microns and less than or equal to 12 microns, or greater than or equal to 4 microns and less than or equal to 10 microns). Maximum pore size may be measured according to ASTM E1294 (2008).

In some embodiments, the first phase is an efficiency layer. In some embodiments, inclusion of the first phase increases the efficiency of the filter media.

In some embodiments, the filter media comprises a second phase. For example, in some embodiments, filter media 100 of FIG. 1 comprises phase 110 (e.g., a second phase). In some embodiments, the second phase is wetlaid (e.g., formed by a wet laying process). In some embodiments, the second phase comprises cellulose fibers and/or synthetic fibers.

Examples of cellulose fibers include softwood fibers, hardwood fibers, a mixture of hardwood and softwood fibers, sheeted fibers, flash dried fibers, regenerated cellulose fibers (e.g., lyocell fibers and/or rayon), and mechanical pulp fibers (e.g., groundwood, chemically treated mechanical pulps, and thermomechanical pulps). Exemplary softwood fibers include fibers obtained from mercerized southern pine (e.g., mercerized southern pine fibers or “HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), or chemically treated mechanical pulps (“CTMP fibers”). Exemplary hardwood fibers include fibers obtained from Eucalyptus (“Eucalyptus fibers”). In some embodiments, inclusion of softwood fibers maintains and/or increases structural flexibility.

The second phase may have any suitable amount of cellulose fibers. In some embodiments, the second phase comprises greater than or equal to 70 wt %, greater than or equal to 75 wt %, greater than or equal to 80 wt %, greater than or equal to 85 wt %, greater than or equal to 90 wt %, or greater than or equal to 95 wt % cellulose fibers compared to the total amount of fibers in the second phase. In some embodiments, the second phase comprises less than or equal to 100 wt %, less than or equal to 95 wt %, less than or equal to 90 wt %, less than or equal to 85 wt %, less than or equal to 80 wt %, or less than or equal to 75 wt % cellulose fibers compared to the total amount of fibers in the second phase. Combinations of these ranges are also possible (e.g., greater than or equal to 70 wt % and less than or equal to 100 wt %, greater than or equal to 80 wt % and less than or equal to 100 wt %, or greater than or equal to 90 wt % and less than or equal to 100 wt % cellulose fibers compared to the total amount of fibers in the second phase). In some embodiments, the second phase comprises 100 wt % cellulose fibers.

In some embodiments, a phase (e.g., a second phase) of a filter media includes softwood fibers. In some embodiments, the cellulose fibers comprise greater than or equal to 30 wt %, greater than or equal to 40 wt %, or greater than or equal to 50 wt %, greater than or equal to 60 wt %, greater than or equal to 70 wt %, greater than or equal to 80 wt %, greater than or equal to 90 wt %, or 100 wt % softwood fibers compared to the total amount of cellulose fibers. In some embodiments, the cellulose fibers comprise less than or equal to 100 wt %, less than or equal to 90 wt %, less than or equal to 80 wt %, less than or equal to 70 wt %, less than or equal to 60 wt %, less than or equal to 50 wt %, or less than or equal to 40 wt % softwood fibers compared to the total amount of cellulose fibers. Combinations of these ranges are possible (e.g., greater than or equal to 30 wt % and less than or equal to 100 wt % softwood fibers compared to the total amount of cellulose fibers).

In some embodiments, a phase (e.g., a second phase) of a filter media includes hardwood fibers. In some embodiments, the cellulose fibers comprise greater than or equal to 1 wt %, greater than or equal to 10 wt %, greater than or equal to 20 wt %, greater than or equal to 30 wt %, greater than or equal to 40 wt %, greater than or equal to 50 wt %, or greater than or equal to 60 wt % hardwood fibers compared to the total amount of cellulose fibers. In some embodiments, the cellulose fibers comprise less than or equal to 70 wt %, less than or equal to 60 wt %, less than or equal to 50 wt %, less than or equal to 40 wt %, less than or equal to 30 wt %, less than or equal to 20 wt %, or less than or equal to 10 wt % hardwood fibers compared to the total amount of cellulose fibers. Combinations of these ranges are also possible (e.g., greater than or equal to 1 wt % and less than or equal to 70 wt % hardwood fibers compared to the total amount of cellulose fibers). In some embodiments, a phase (e.g., a second phase) of a filter media includes 0% hardwood fibers.

In embodiments in which cellulose fibers are present, the cellulose fibers may have any suitable average diameter. In some embodiments, the cellulose fibers have an average diameter of greater than or equal to 10 microns, greater than or equal to 15 microns, greater than or equal to 20 microns, greater than or equal to 25 microns, greater than or equal to 30 microns, greater than or equal to 35 microns, or greater than or equal to 40 microns. In some embodiments, the cellulose fibers have an average diameter of less than or equal to 50 microns, less than or equal to 45 microns, less than or equal to 40 microns, less than or equal to 35 microns, less than or equal to 30 microns, less than or equal to 25 microns, less than or equal to 20 microns, or less than or equal to 15 microns. Combinations of these ranges are also possible (e.g., greater than or equal to 10 microns and less than or equal to 50 microns, greater than or equal to 10 microns and less than or equal to 40 microns, or greater than or equal to 10 microns and less than or equal to 30 microns).

The cellulose fibers may have any suitable average length. In some embodiments, the cellulose fibers have an average length of greater than or equal to 1 millimeter, greater than or equal to 2 millimeters, greater than or equal to 3 millimeters, greater than or equal to 4 millimeters, greater than or equal to 5 millimeters, greater than or equal to 6 millimeters, or greater than or equal to 7 millimeters. In some embodiments, the cellulose fibers have an average length of less than or equal to 8 millimeters, less than or equal to 7 millimeters, less than or equal to 6 millimeters, less than or equal to 5 millimeters, less than or equal to 4 millimeters, less than or equal to 3 millimeters, or less than or equal to 2 millimeters. Combinations of these ranges are also possible (e.g., greater than or equal to 1 millimeter and less than or equal to 8 millimeters, greater than or equal to 1 millimeter and less than or equal to 6 millimeters, or greater than or equal to 1 millimeter and less than or equal to 5 millimeters).

In some embodiments, a phase (e.g., second phase) includes synthetic fibers. Non-limiting examples of suitable synthetic fibers include fibers comprising one or more of the following materials: poly(ester)s (e.g., poly(ethylene terephthalate), poly(butylene terephthalate)), poly(carbonate), poly(amide)s (e.g., various nylon polymers), poly(aramid)s, poly(imide)s, poly(olefin)s (e.g., poly(ethylene), poly(propylene)), poly(ether ketone), poly(acrylic)s (e.g., poly(acrylonitrile)), poly(vinyl alcohol), regenerated cellulose (e.g., synthetic cellulose such cellulose acetate, lyocell, rayon), fluorinated polymers (e.g., poly(vinylidene difluoride) (PVDF)), copolymers of poly(ethylene) and PVDF, and poly(ether sulfone)s. In some embodiments, the synthetic fibers comprise organic polymer fibers. In some embodiments, the synthetic fibers comprise polyester fibers. In some embodiments, the synthetic fibers are staple fibers (e.g., polyester staple fibers).

The second phase may have any suitable amount of synthetic fibers. In some embodiments, the second phase comprises greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %, greater than or equal to 11 wt %, greater than or equal to 12 wt %, greater than or equal to 13 wt %, greater than or equal to 14 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 70 wt %, greater than or equal to 80 wt %, or greater than or equal to 90 wt % synthetic fibers compared to the total amount of fibers in the second phase. In some embodiments, the second phase comprises less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, or less than or equal to 10 wt % synthetic fibers compared to the total amount of fibers in the second phase. Combinations of these ranges are also possible (e.g., greater than or equal to 1 wt % and less than or equal to 100 wt %, greater than or equal to 1 wt % and less than or equal to 50 wt %, greater than or equal to 10 wt % and less than or equal to 30 wt %, or greater than or equal to 15 wt % and less than or equal to 25 wt % synthetic fibers compared to the total amount of fibers in the second phase). In some embodiments, the second phase comprises 100 wt % synthetic fibers.

In embodiments in which synthetic fibers are present (e.g., in the second phase), the synthetic fibers may have any suitable average diameter. In some embodiments, the synthetic fibers have an average diameter of greater than or equal to 0.75 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 12 microns, greater than or equal to 14 microns, greater than or equal to 16 microns, greater than or equal to 18 microns, greater than or equal to 20 microns, greater than or equal to 22 microns, or greater than or equal to 24 microns. In some embodiments, the synthetic fibers have an average diameter of less than or equal to 25 microns, less than or equal to 23 microns, less than or equal to 20 microns, less than or equal to 17 microns, less than or equal to 15 microns, less than or equal to 13 microns, less than or equal to 10 microns, less than or equal to 9.5 microns, less than or equal to 9 microns, less than or equal to 8.5 microns, less than or equal to 8 microns, less than or equal to 7.5 microns, less than or equal to 7 microns, less than or equal to 6.5 microns, less than or equal to 6 microns, less than or equal to 5 microns, less than or equal to 4 microns, less than or equal to 3 microns, or less than or equal to 2 microns. Combinations of these ranges are also possible (e.g., greater than or equal to 0.75 microns and less than or equal to 25 microns, greater than or equal to 4 microns and less than or equal to 20 microns, or greater than or equal to 5 microns and less than or equal to 17 microns).

The synthetic fibers may have any suitable average length. In some embodiments, the synthetic fibers have an average length of greater than or equal to 0.5 millimeters, greater than or equal to 1 millimeters, greater than or equal to 2 millimeters, greater than or equal to 3 millimeters, greater than or equal to 4 millimeters, greater than or equal to 5 millimeters, greater than or equal to 10 millimeters, greater than or equal to 15 millimeters, greater than or equal to 20 millimeters, or greater than or equal to 25 millimeters. In some embodiments, the synthetic fibers have an average length of less than or equal to 20 millimeters, less than or equal to 18 millimeters, less than or equal to 15 millimeters, less than or equal to 12 millimeters, less than or equal to 10 millimeters, less than or equal to 5 millimeters, less than or equal to 4 millimeters, less than or equal to 3 millimeters, less than or equal to 2 millimeters, or less than or equal to 1 millimeter. Combinations of these ranges are also possible (e.g., greater than or equal to 0.5 millimeters and less than or equal to 20 millimeters, greater than or equal to 2 millimeters and less than or equal to 15 millimeters, or greater than or equal to 3 millimeters and less than or equal to 12 millimeters).

Regardless of the type of fiber(s) in the second phase, the fibers of the second phase may have any suitable average fiber diameter. In some embodiments, the second phase may have an average fiber diameter of greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 15 microns, greater than or equal to 20 microns, greater than or equal to 25 microns, greater than or equal to 30 microns, or greater than or equal to 40 microns. In some embodiments, the second phase may have an average fiber diameter of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 5 microns, less than or equal to 4 microns, or less than or equal to 3 microns. Combinations of these ranges are also possible (e.g., greater than or equal to 1 micron and less than or equal to 50 microns, greater than or equal to 4 microns and less than or equal to 40 microns, or greater than or equal to 5 microns and less than or equal to 30 microns).

Regardless of the type of fibers(s) is the second phase, the fibers of the second phase may have any suitable average fiber length. In some embodiments, the second phase has an average fiber length of greater than or equal to 0.1 mm, greater than or equal to 0.2 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.25 mm, greater than or equal to 1.5 mm, greater than or equal to 2 mm, greater than or equal to 3 mm, greater than or equal to 4 mm, greater than or equal to 5 mm, greater than or equal to 7 mm, greater than or equal to 10 mm, greater than or equal to 15 mm, greater than or equal to 20 mm, or greater than or equal to 25 mm. In some embodiments, the second phase has an average fiber length of less than or equal to 30 mm, less than or equal to 25 mm, less than or equal to 20 mm, less than or equal to 15 mm, less than or equal to 10 mm, less than or equal to 7 mm, less than or equal to 5 mm, less than or equal to 4 mm, less than or equal to 3 mm, less than or equal to 2 mm, less than or equal to 1.5 mm, less than or equal to 1.25 mm, less than or equal to 1 mm, less than or equal to 0.9 mm, less than or equal to 0.8 mm, less than or equal to 0.7 mm, less than or equal to 0.6 mm, less than or equal to 0.5 mm, less than or equal to 0.4 mm, less than or equal to 0.3 mm, or less than or equal to 0.2 mm. Combinations of these ranges are also possible (e.g., greater than or equal to 0.1 mm and less than or equal to 30 mm or greater than or equal to 0.1 mm and less than or equal to 20 mm).

The second phase may have any suitable basis weight. In some embodiments, the basis weight of the second phase is greater than or equal to 25 gsm, greater than or equal to 30 gsm, greater than or equal to 35 gsm, greater than or equal to 40 gsm, greater than or equal to 45 gsm, greater than or equal to 50 gsm, greater than or equal to 55 gsm, greater than or equal to 60 gsm, greater than or equal to 65 gsm, greater than or equal to 70 gsm, greater than or equal to 75 gsm, greater than or equal to 80 gsm, greater than or equal to 90 gsm, greater than or equal to 100 gsm, greater than or equal to 125 gsm, greater than or equal to 150 gsm, greater than or equal to 175 gsm, or greater than or equal to 200 gsm. In some embodiments, the basis weight of the second phase is less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, or less than or equal to 30 gsm. Combinations of these ranges are also possible (e.g., greater than or equal to 25 gsm and less than or equal to 250 gsm, greater than or equal to 70 gsm and less than or equal to 200 gsm, or greater than or equal to 80 gsm and less than or equal to 150 gsm).

The second phase may have any suitable thickness. In some embodiments, the thickness of the second phase is greater than or equal to 0.1 millimeters, greater than or equal to 0.2 millimeters, greater than or equal to 0.3 millimeters, greater than or equal to 0.4 millimeters, greater than or equal to 0.5 millimeters, greater than or equal to 0.6 millimeters, greater than or equal to 0.7 millimeters, greater than or equal to 0.8 millimeters, or greater than or equal to 0.9 millimeters. In some embodiments, the thickness of the second phase is less than or equal to 1 millimeter, less than or equal to 0.9 millimeters, less than or equal to 0.8 millimeters, less than or equal to 0.7 millimeters, less than or equal to 0.6 millimeters, less than or equal to 0.5 millimeters, less than or equal to 0.4 millimeters, less than or equal to 0.3 millimeters, or less than or equal to 0.2 millimeters. Combinations of these ranges are also possible (e.g., greater than or equal to 0.1 millimeters and less than or equal to 1 millimeter, greater than or equal to 0.2 millimeters and less than or equal to 0.7 millimeters, or greater than or equal to 0.3 millimeters and less than or equal to 0.6 millimeters).

The second phase may have any suitable air permeability. In some embodiments, the air permeability of the second phase is greater than or equal to 1 CFM, greater than or equal to 2 CFM, greater than or equal to 3 CFM, greater than or equal to 4 CFM, greater than or equal to 5 CFM, greater than or equal to 10 CFM, greater than or equal to 20 CFM, greater than or equal to 25 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, greater than or equal to 400 CFM, greater than or equal to 500 CFM, greater than or equal to 600 CFM, or greater than or equal to 700 CFM. In some embodiments, the air permeability of the second phase is less than or equal to 800 CFM, less than or equal to 700 CFM, less than or equal to 600 CFM, less than or equal to 500 CFM, less than or equal to 400 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 25 CFM, less than or equal to 20 CFM, less than or equal to 10 CFM, or less than or equal to 5 CFM. Combinations of these ranges are also possible (e.g., greater than or equal to 1 CFM and less than or equal to 800 CFM, greater than or equal to 2 CFM and less than or equal to 200 CFM, or greater than or equal to 3 CFM and less than or equal to 100 CFM).

The second phase may have any suitable mean flow pore size. In some embodiments, the mean flow pore size of the second phase is greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 15 microns, greater than or equal to 20 microns, or greater than or equal to 25 microns. In some embodiments, the mean flow pore size of the second phase is less than or equal to 30 microns, less than or equal to 29 microns, less than or equal to 28 microns, less than or equal to 27 microns, less than or equal to 26 microns, less than or equal to 25 microns, less than or equal to 24 microns, less than or equal to 23 microns, less than or equal to 22 microns, less than or equal to 21 microns, less than or equal to 20 microns, less than or equal to 15 microns, less than or equal to 10 microns, less than or equal to 9 microns, less than or equal to 8 microns, less than or equal to 7 microns, less than or equal to 6 microns, less than or equal to 5 microns, less than or equal to 4 microns, or less than or equal to 3 microns. Combinations of these ranges are also possible (e.g., greater than or equal to 2 microns and less than or equal to 30 microns, greater than or equal to 5 microns and less than or equal to 25 microns, or greater than or equal to 5 microns and less than or equal to 20 microns).

The second phase may have any suitable maximum pore size. In some embodiments, the second phase has a maximum pore size of greater than or equal to 5 microns, greater than or equal to 7 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 20 microns, greater than or equal to 25 microns, or greater than or equal to 30 microns. In some embodiments, the second phase has a maximum pore size of less than or equal to 80 microns, less than or equal to 70 microns, less than or equal to 60 microns, less than or equal to 50 microns, less than or equal to 40 microns, less than or equal to 30 microns, less than or equal to 20 microns, less than or equal to 15 microns, or less than or equal to 10 microns. Combinations of these ranges are also possible (e.g., greater than or equal to 5 microns and less than or equal to 80 microns, greater than or equal to 10 microns and less than or equal to 30 microns, or greater than or equal to 15 microns and less than or equal to 50 microns).

The second phase may have any suitable dry Mullen burst strength. In some embodiments, the dry Mullen burst strength of the second phase is greater than or equal to 50 kPa, greater than or equal to 55 kPa, greater than or equal to 60 kPa, greater than or equal to 65 kPa, greater than or equal to 70 kPa, greater than or equal to 75 kPa, greater than or equal to 80 kPa, greater than or equal to 90 kPa, greater than or equal to 100 kPa, greater than or equal to 125 kPa, greater than or equal to 150 kPa, greater than or equal to 175 kPa, greater than or equal to 200 kPa, or greater than or equal to 225 kPa. In some embodiments, the dry Mullen burst strength of the second phase is less than or equal to 250 kPa, less than or equal to 225 kPa, less than or equal to 200 kPa, less than or equal to 175 kPa, less than or equal to 150 kPa, less than or equal to 125 kPa, less than or equal to 100 kPa, less than or equal to 90 kPa, less than or equal to 80 kPa, or less than or equal to 70 kPa. Combinations of these ranges are also possible (e.g., greater than or equal to 50 kPa and less than or equal to 250 kPa, greater than or equal to 70 kPa and less than or equal to 250 kPa, or greater than or equal to 80 kPa and less than or equal to 250 kPa). In some embodiments, the second phase is a support layer. In some embodiments, inclusion of the second phase increases the stiffness and/or pleatability of the filter media.

In some embodiments, the first phase and/or the second phase may each independently comprise a resin. Examples of suitable resins include polyesters, poly(olefin)s, vinyl compounds (e.g., acrylics, styrenated acrylics, vinyl acetates, vinyl acrylics, poly(styrene acrylate), poly(acrylate)s, poly(vinyl alcohol), poly(ethylene vinyl acetate), poly(ethylene vinyl chloride), styrene butadiene rubber, poly(vinyl chloride), poly(vinyl alcohol) derivatives), poly(urethane), poly(amide)s, poly(nitrile)s, elastomers, natural rubber, urea formaldehyde, melamine formaldehyde, phenol formaldehyde, epoxy-based resins, starch polymers and combinations thereof. It should be understood that other resin compositions may also be suitable. In some embodiments, the resin may be a thermoset and, in some embodiments, a thermoset/thermoplastic combination. The resin may be in the form of a solvent based dispersion or emulsion, The resin may be in the form of a latex such as a water-based emulsion or dispersion. In some embodiments, the resin may be in the form of a dispersion, powder, hot melt, and/or solution. In some embodiments, the resin comprises a thermoset resin based on phenolic and/or epoxy. In some embodiments, the resin comprises phenol and/or acrylates. In some embodiments, the resin comprises a crosslinking agent.

The first phase and/or the second phase may each independently comprise any suitable amount of resin. In some embodiments, the first phase and/or the second phase each independently comprises greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %, greater than or equal to 11 wt %, greater than or equal to 12 wt %, greater than or equal to 15 wt %, greater than or equal to 20 wt %, greater than or equal to 25 wt %, greater than or equal to 30 wt %, or greater than or equal to 35 wt % resin compared to the total weight of the first phase and/or the second phase. In some embodiments, the first phase and/or the second phase each independently comprises less than or equal to 40 wt %, less than or equal to 38 wt %, less than or equal to 35 wt %, less than or equal to 33 wt %, less than or equal to 30 wt %, less than or equal to 27 wt %, less than or equal to 25 wt %, less than or equal to 22 wt %, less than or equal to 20 wt %, less than or equal to 18 wt %, less than or equal to 15 wt %, less than or equal to 10 wt %, less than or equal to 5 wt %, less than or equal to 4 wt %, or less than or equal to 3 wt % resin compared to the total weight of the first phase and/or the second phase. Combinations of these ranges are also possible (e.g., greater than or equal to 2 wt % and less than or equal to 40 wt %, greater than or equal to 5 wt % and less than or equal to 25 wt %, or greater than or equal to 10 wt % and less than or equal to 20 wt % resin compared to the total weight of the first phase and/or the second phase).

In some embodiments, inclusion of the resin increases the strength of the first phase and/or the second phase. In some embodiments, inclusion of the resin increases the flexibility of the first phase and/or the second phase.

In some embodiments, the first phase and/or the second phase may each independently comprise binder fibers. The binder fibers may be monocomponent (i.e., having a single composition) or may be multicomponent (i.e., having multiple compositions such as bi-component fiber). An example of a multi-component fiber is a bi-component fiber which includes a first material and a second material that is different from the first material. The different components of a multi-component fiber may exhibit a variety of spatial arrangements. For example, multi-component fibers may be arranged in a core-sheath configuration (e.g., a first material may be a sheath material that surrounds a second material which is a core material), a side by side configuration (e.g., a first material may be arranged adjacent to a second material), a segmented pie arrangement (e.g., different materials may be arranged adjacent to one another in a wedged configuration), a tri-lobal arrangement (e.g., a tip of a lobe may have a material different from the lobe) and an arrangement of localized regions of one component in a different component (e.g., “islands in sea”).

In some embodiments, for a core-sheath configuration, a multi-component fiber, such as a bi-component fiber, may include a sheath of a first material that surrounds a core comprising a second material. In such an arrangement, for some embodiments, the melting point of the first material may be lower than the melting point of the second material. Accordingly, at a suitable step during manufacture of a fiber web (e.g., drying), the first material comprising the sheath may be melted (e.g., may exhibit a phase change) while the second material comprising the core remains unaltered (e.g., may exhibit no phase change). For instance, an outer sheath portion of a multi-component fiber may have a melting temperature between about 50° C. and about 200° C. (e.g., 180° C.) and an inner core of the multi-component fiber may have a melting temperature above 200° C. As a result, when the fiber is subjected to a temperature during drying, e.g., at 180° C., then the outer sheath of the fiber may melt while the core of the fiber does not melt.

Non-limiting examples of suitable binder fiber materials include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460, such as diethylene ether glycol).

The first phase and/or the second phase may each independently comprise any suitable amount of binder fibers. In some embodiments, the first phase and/or the second phase each independently comprises greater than or equal to 0 wt %, greater than or equal to 1 wt %, greater than or equal to 2 wt %, greater than or equal to 4 wt %, greater than or equal to 5 wt %, greater than or equal to 6 wt %, greater than or equal to 8 wt %, greater than or equal to 10 wt %, greater than or equal to 12 wt %, greater than or equal to 14 wt %, greater than or equal to 16 wt %, greater than or equal to 18 wt %, greater than or equal to 20 wt %, greater than or equal to 25 wt %, greater than or equal to 30 wt %, greater than or equal to 40 wt %, or greater than or equal to 50 wt % binder fibers compared to the total weight of the first phase and/or the second phase. In some embodiments, the first phase and/or the second phase each independently comprises less than or equal to 60 wt %, less than or equal to 50 wt %, less than or equal to 40 wt %, less than or equal to 30 wt %, less than or equal to 20 wt %, less than or equal to 18 wt %, less than or equal to 16 wt %, less than or equal to 14 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % binder fibers compared to the total weight of the first phase and/or the second phase. Combinations of these ranges are also possible (e.g., greater than or equal to 0 wt % (or 1 wt %) and less than or equal to 60 wt %, greater than or equal to 0 wt % (or 1 wt %) and less than or equal to 50 wt %, or greater than or equal to 0 wt % (or 1 wt %) and less than or equal to 40 wt %). In some embodiments, the first phase and/or second phase comprises 0 wt % binder fibers compared to the total weight of the first phase and/or the second phase.

In some embodiments, the filter media comprises a multi-phase layer. As used herein, a layer is discrete, while a phase is a region of a layer. In some embodiments, the layer is formed by a multi-phase process formation, such as that described below.

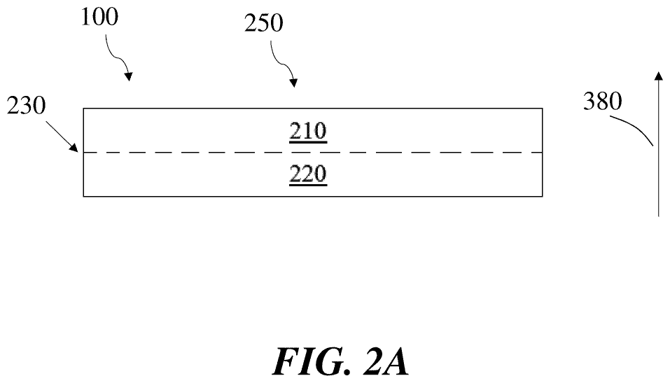

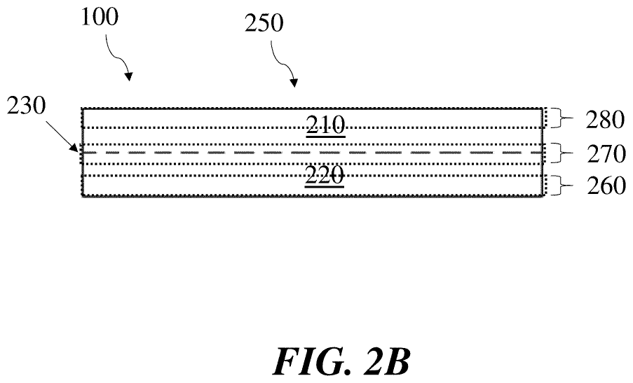

In some embodiments, the filter media comprises a multi-phase layer (e.g., a dual phase layer). For example, in some embodiments, a filter media 100 of FIG. 2A comprises a multi-phase layer 250 (e.g., a dual phase layer). In some embodiments, the multi-phase layer (e.g., the dual phase layer) comprises the first phase and the second phase. For example, in some embodiments, multi-phase layer 250 (e.g., dual phase layer) of FIG. 2A comprises a first phase 210 and a second phase 220. In some embodiments, the first phase is adjacent to the second phase. For example, in some embodiments, first phase 210 of FIG. 2A is adjacent to second phase 220. In some embodiments, there are no intervening phases between the first phase and second phase. For example, in some embodiments, there are no intervening phases between first phase 210 of FIG. 2A and second phase 220.

In some embodiments, there is an interface between the first phase and second phase where they contact each other. For example, in some embodiments, there is an interface 230 between first phase 210 of FIG. 2A and second phase 220. The interface may form a transition phase between the first and second phases, whereby the transition phase comprises at least a portion of the fibers of the first and second phases. For example, in some embodiments in which the first phase comprises a first plurality of fibers and a second plurality of fibers, and the second phase comprises a third plurality fibers (and an optional fourth plurality of fibers), the transition phase may include at least a portion of the first plurality of fibers, at least a portion of the second plurality of fibers, at least a portion of the third plurality of fibers (and optionally, at least a portion of the fourth plurality of fibers). In the transition phase, at least a portion of the first plurality of fibers, at least a portion of the second plurality of fibers, at least a portion of the third plurality of fibers (and optionally, at least a portion of the fourth plurality of fibers) are intermingled with each other.

In some embodiments, the multi-phase layer (e.g., the dual phase layer) comprises fibrillated fibers, glass fibers, cellulose fibers, and/or synthetic fibers. In some embodiments, the multi-phase layer (e.g., the dual phase layer) is wet laid (e.g., formed by a wet laying process). An example of a wet laying process that can be used to form a multi-phase layer (e.g., a dual phase layer) is as follows: First, a first dispersion (e.g., a pulp) containing first and second pluralities of fibers in a solvent (e.g., an aqueous solvent such as water) can be applied onto a wire conveyor in a papermaking machine (e.g., a fourdrinier or a rotoformer) to form a first phase supported by the wire conveyor. A second dispersion (e.g., another pulp) containing a third plurality of fibers (and, optionally a fourth plurality of fibers) in a solvent (e.g., an aqueous solvent such as water) is then applied onto the first phase. Vacuum is continuously applied to the first and second dispersions of fibers during the above process to remove the solvent from the fibers, thereby resulting in an article containing the first phase and the second phase. The article thus formed is then dried and, if necessary, further processed.

In some embodiments, the first phase and second phase in the multi-phase layer (e.g., the dual phase layer) do not have macroscopic phase separation (e.g., where one layer is laminated onto another layer in the filter medium), but instead contain an interface in which microscopic phase transition occurs depending on the fibers used or the forming process (e.g., how much vacuum is applied). The interface may form a transition phase between the first and second phases. In some embodiments, at least a portion of the fibers of the first phase are intermingled with at least a portion of the fibers of the second phase at an interface of the first phase and the second phase. For example, in some embodiments, multi-phase layer 250 (e.g., dual phase layer) of FIG. 2A comprises first phase 210 and second phase 220, and at least a portion of the fibers of first phase 210 are intermingled with at least a portion of the fibers of second phase 220 at interface 230.

The multi-phase layer (e.g., the dual phase layer) may comprise any suitable amount of fibrillated fibers. In some embodiments, the multi-phase layer (e.g., the dual phase layer) comprises greater than or equal to 15 wt %, greater than or equal to 16 wt %, greater than or equal to 17 wt %, greater than or equal to 18 wt %, greater than or equal to 19 wt %, greater than or equal to 20 wt %, greater than or equal to 25 wt %, greater than or equal to 30 wt %, greater than or equal to 35 wt %, greater than or equal to 40 wt %, or greater than or equal to 45 wt % fibrillated fibers compared to the total amount of fibers in the multi-phase layer (e.g., the dual phase layer). In some embodiments, the multi-phase layer (e.g., the dual phase layer) comprises less than or equal to 50 wt %, less than or equal to 45 wt %, less than or equal to 40 wt %, less than or equal to 35 wt %, less than or equal to 30 wt %, less than or equal to 25 wt %, or less than or equal to 20 wt % fibrillated fibers compared to the total amount of fibers in the multi-phase layer (e.g., the dual phase layer). Combinations of these ranges are also possible (e.g., greater than or equal to 15 wt % and less than or equal to 50 wt %, greater than or equal to 15 wt % and less than or equal to 40 wt %, or greater than or equal to 20 wt % and less than or equal to 35 wt % fibrillated fibers compared to the total amount of fibers in the multi-phase layer (e.g., the dual phase layer)).

The multi-phase layer (e.g., dual phase layer) may comprise any suitable amount of glass fibers. In some embodiments, the multi-phase layer (e.g., dual phase layer) comprises greater than or equal to 10 wt %, greater than or equal to 11 wt %, greater than or equal to 12 wt %, greater than or equal to 13 wt %, greater than or equal to 14 wt %, greater than or equal to 15 wt %, greater than or equal to 16 wt %, greater than or equal to 17 wt %, greater than or equal to 18 wt %, greater than or equal to 19 wt %, greater than or equal to 20 wt %, greater than or equal to 25 wt %, greater than or equal to 30 wt %, or greater than or equal to 35 wt % glass fibers compared to the total amount of fibers in the multi-phase layer (e.g., dual phase layer). In some embodiments, the multi-phase layer (e.g., dual phase layer) comprises less than or equal to 40 wt %, less than or equal to 39 wt %, less than or equal to 38 wt %, less than or equal to 37 wt %, less than or equal to 36 wt %, less than or equal to 35 wt %, less than or equal to 34 wt %, less than or equal to 33 wt %, less than or equal to 32 w %, less than or equal to 31 wt %, less than or equal to 30 wt %, less than or equal to 25 wt %, less than or equal to 20 wt %, or less than or equal to 15 wt % glass fibers compared to the total amount of fibers in the multi-phase layer (e.g., dual phase layer). Combinations of these ranges are also possible (e.g., greater than or equal to 10 wt % and less than or equal to 40 wt %, greater than or equal to 15 wt % and less than or equal to 35 wt %, or greater than or equal to 20 wt % and less than or equal to 30 wt % glass fibers compared to the total amount of fibers in the multi-phase layer (e.g., dual phase layer)).

In some embodiments, the multi-phase layer (e.g., dual phase layer) comprises greater than or equal to 10 wt % and less than or equal to 40 wt % glass fibers and greater than or equal to 15 wt % and less than or equal to 50 wt % fibrillated fibers compared to the total fiber content of the multi-phase layer (e.g., dual phase layer). In some embodiments, the multi-phase layer (e.g., dual phase layer) comprises greater than or equal to 15 wt % and less than or equal to 35 wt % glass fibers and greater than or equal to 15 wt % and less than or equal to 40 wt % fibrillated fibers compared to the total fiber content of the multi-phase layer (e.g., dual phase layer). In some embodiments, the multi-phase layer (e.g., dual phase layer) comprises greater than or equal to 20 wt % and less than or equal to 30 wt % glass fibers and greater than or equal to 20 wt % and less than or equal to 35 wt % fibrillated fibers compared to the total fiber content of the multi-phase layer (e.g., dual phase layer).

The multi-phase layer (e.g., dual phase layer) may comprise any suitable amount of cellulose fibers and/or synthetic fibers. In some embodiments, the multi-phase layer (e.g., dual phase layer) comprises greater than or equal to 30 wt %, greater than or equal to 31 wt %, greater than or equal to 32 wt %, greater than or equal to 33 wt %, greater than or equal to 34 wt %, greater than or equal to 35 wt %, greater than or equal to 36 wt %, greater than or equal to 37 wt %, greater than or equal to 38 wt %, greater than or equal to 39 wt %, greater than or equal to 40 wt %, greater than or equal to 45 wt %, greater than or equal to 50 wt %, greater than or equal to 60 wt %, or greater than or equal to 70 wt % cellulose fibers and/or synthetic fibers compared to the total amount of fibers in the multi-phase layer (e.g., dual phase layer). In some embodiments, the multi-phase layer (e.g., dual phase layer) comprises less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, or less than or equal to 35 wt % cellulose fibers and/or synthetic fibers compared to the total amount of fibers in the multi-phase layer (e.g., dual phase layer). Combinations of these ranges are also possible (e.g., greater than or equal to 30 wt % and less than or equal to 80 wt %, greater than or equal to 35 wt % and less than or equal to 70 wt %, or greater than or equal to 40 wt % and less than or equal to 60 wt % cellulose fibers and/or synthetic fibers compared to the total amount of fibers in the multi-phase layer (e.g., dual phase layer)). In some embodiments, the above-referenced ranges refer to the amount of cellulose fibers in the multi-phase layer (e.g., dual phase layer). In other embodiments, the above-referenced ranges refer to the amount of synthetic fibers in the multi-phase layer (e.g., dual phase layer). In yet other embodiments, the above-referenced ranges refer to the amount of combined cellulose fibers and synthetic fibers in the multi-phase layer (e.g., dual phase layer).

In some embodiments, at least a portion, or all, of the multi-phase layer (e.g., dual phase layer) comprises a gradient in the amount of one or more types of fibers (e.g., glass fibers, fibrillated fibers, cellulose fibers and/or synthetic fibers) in the z-direction. For example, in some embodiments, the multi-phase layer (e.g., the dual phase layer) comprises a gradient in the amount of one or more types of fibers in z-direction 380. In some embodiments, a first volume portion (e.g., at the outermost surface) of the first phase of the multi-phase layer (e.g., the dual phase layer) has a first concentration of glass fibers and/or fibrillated fibers and a second volume portion (e.g., at the outermost surface) of the second phase of the multi-phase layer (e.g., dual phase layer) has a second concentration of glass fibers and/or fibrillated fibers (which may comprise 0 wt %). For example, in some embodiments, a first volume portion 280 of the filter media shown in FIG. 2B has a first concentration of glass fibers and/or fibrillated fibers and a second volume portion 260 of the cross-section has a second concentration of glass fibers and/or fibrillated fibers. In some embodiments, the first concentration is different than the second concentration. In some embodiments, the first concentration is greater than the second concentration. In some embodiments, a third volume portion at the interface of the first phase and the second phase of the multi-phase layer (e.g., dual phase layer) has a third concentration of glass fibers and/or fibrillated fibers. For example, in some embodiments, a third volume portion 270 has a third concentration of glass fibers and/or fibrillated fibers. In some embodiments, the first, second, and third concentrations are each different. In some embodiments, the first concentration is greater than the third concentration and/or the second concentration is less than the third concentration. In some embodiments, each volume portion is the same volume. For example, in some embodiments, each volume portion is the full XY-plane of the multi-phase layer (e.g., dual phase layer) by ⅓ of the z-direction of the multi-phase layer (e.g., dual phase layer).

Regardless of the type of fibers(s) is the first phase, the fibers of the multi-phase layer (e.g., dual phase layer) may have any suitable average fiber diameter. In some embodiments, the average fiber diameter of the multi-phase layer (e.g., dual phase layer) is greater than or equal to 0.1 microns, greater than or equal to 0.2 microns, greater than or equal to 0.3 microns, greater than or equal to 0.4 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, the average fiber diameter of the multi-phase layer (e.g., dual phase layer) is less than or equal to 50 microns, less than or equal to 45 microns, less than or equal to 40 microns, less than or equal to 35 microns, less than or equal to 30 microns, less than or equal to 29 microns, less than or equal to 28 microns, less than or equal to 27 microns, less than or equal to 26 microns, less than or equal to 25 microns, less than or equal to 24 microns, less than or equal to 23 microns, less than or equal to 22 microns, less than or equal to 21 microns, less than or equal to 20 microns, less than or equal to 15 microns, less than or equal to 10 microns, or less than or equal to 5 microns. Combinations of these ranges are also possible (e.g., greater than or equal to 0.1 microns and less than or equal to 50 microns, greater than or equal to 0.1 microns and less than or equal to 30 microns, greater than or equal to 0.1 microns and less than or equal to 25 microns, or greater than or equal to 0.2 microns and less than or equal to 20 microns).

Regardless of the type of fibers(s) is the multi-phase layer (e.g., dual phase layer), the fibers of the multi-phase layer (e.g., dual phase layer) may have any suitable average fiber length. In some embodiments, the multi-phase layer (e.g., dual phase layer) has an average fiber length of greater than or equal to 0.1 mm, greater than or equal to 0.2 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.25 mm, greater than or equal to 1.5 mm, greater than or equal to 2 mm, greater than or equal to 3 mm, greater than or equal to 4 mm, greater than or equal to 5 mm, greater than or equal to 7 mm, greater than or equal to 10 mm, greater than or equal to 15 mm, greater than or equal to 20 mm, or greater than or equal to 25 mm. In some embodiments, the multi-phase layer (e.g., dual phase layer) has an average fiber length of less than or equal to 30 mm, less than or equal to 25 mm, less than or equal to 20 mm, less than or equal to 15 mm, less than or equal to 10 mm, less than or equal to 7 mm, less than or equal to 5 mm, less than or equal to 4 mm, less than or equal to 3 mm, less than or equal to 2 mm, less than or equal to 1.5 mm, less than or equal to 1.25 mm, less than or equal to 1 mm, less than or equal to 0.9 mm, less than or equal to 0.8 mm, less than or equal to 0.7 mm, less than or equal to 0.6 mm, less than or equal to 0.5 mm, less than or equal to 0.4 mm, less than or equal to 0.3 mm, or less than or equal to 0.2 mm. Combinations of these ranges are also possible (e.g., greater than or equal to 0.1 mm and less than or equal to 30 mm or greater than or equal to 0.1 mm and less than or equal to 20 mm).

The multi-phase layer (e.g., dual phase layer) may have any suitable amount of resin. In some embodiments, the multi-phase layer (e.g., dual phase layer) has greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %, greater than or equal to 15 wt %, greater than or equal to 20 wt %, greater than or equal to 25 wt %, greater than or equal to 30 wt %, or greater than or equal to 35 wt % resin compared to the total weight of the multi-phase layer (e.g., dual phase layer). In some embodiments, the multi-phase layer (e.g., dual phase layer) has less than or equal to 40 wt %, less than or equal to 38 wt %, less than or equal to 35 wt %, less than or equal to 32 wt %, less than or equal to 30 wt %, less than or equal to 28 wt %, less than or equal to 25 wt %, less than or equal to 20 wt %, less than or equal to 15 wt %, less than or equal to 10 wt %, or less than or equal to 5 wt % resin compared to the total weight of the multi-phase layer (e.g., dual phase layer). Combinations of these ranges are also possible (e.g., greater than or equal to 2 wt % and less than or equal to 40 wt %, greater than or equal to 5 wt % and less than or equal to 30 wt %, or greater than or equal to 10 wt % and less than or equal to 25 wt % resin compared to the total weight of the multi-phase layer (e.g., dual phase layer)).

The multi-phase layer (e.g., dual phase layer) may have any suitable basis weight. In some embodiments, the multi-phase layer (e.g., dual phase layer) has a basis weight of greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, or greater than or equal to 275 gsm. In some embodiments, the multi-phase layer (e.g., dual phase layer) has a basis weight of less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 90 gsm, less than or equal to 80 gsm, or less than or equal to 70 gsm. Combinations of these ranges are also possible (e.g., greater than or equal to 50 gsm and less than or equal to 300 gsm, greater than or equal to 80 gsm and less than or equal to 250 gsm, or greater than or equal to 100 gsm and less than or equal to 200 gsm).

The multi-phase layer (e.g., dual phase layer) may have any suitable thickness. In some embodiments, the thickness of the multi-phase layer (e.g., dual phase layer) is greater than or equal to 0.1 millimeters, greater than or equal to 0.2 millimeters, greater than or equal to 0.3 millimeters, greater than or equal to 0.4 millimeters, greater than or equal to 0.5 millimeters, greater than or equal to 0.6 millimeters, greater than or equal to 0.7 millimeters, greater than or equal to 0.8 millimeters, greater than or equal to 0.9 millimeters, greater than or equal to 1 millimeter, greater than or equal to 1.25 millimeters, greater than or equal to 1.5 millimeters, or greater than or equal to 1.75 millimeters. In some embodiments, the thickness of the multi-phase layer (e.g., dual phase layer) is less than or equal to 2 millimeters, less than or equal to 1.9 millimeters, less than or equal to 1.8 millimeters, less than or equal to 1.7 millimeters, less than or equal to 1.6 millimeters, less than or equal to 1.5 millimeters, less than or equal to 1.4 millimeters, less than or equal to 1.3 millimeters, less than or equal to 1.2 millimeters, less than or equal to 1 millimeter, less than or equal to 0.75 millimeters, less than or equal to 0.5 millimeters, or less than or equal to 0.25 millimeters. Combinations of these ranges are also possible (e.g., greater than or equal to 0.1 millimeters and less than or equal to 2 millimeters, greater than or equal to 0.2 millimeters and less than or equal to 1.8 millimeters, or greater than or equal to 0.3 millimeters and less than or equal to 1.5 millimeters).

The multi-phase layer (e.g., dual phase layer) may have any suitable air permeability. In some embodiments, the air permeability of the multi-phase layer (e.g., dual phase layer) is greater than or equal to 0.1 CFM, greater than or equal to 0.2 CFM, greater than or equal to 0.3 CFM, greater than or equal to 0.4 CFM, greater than or equal to 0.5 CFM, greater than or equal to 0.75 CFM, greater than or equal to 1 CFM, greater than or equal to 1.25 CFM, greater than or equal to 1.5 CFM, greater than or equal to 1.75 CFM, greater than or equal to 2 CFM, greater than or equal to 3 CFM, greater than or equal to 4 CFM, greater than or equal to 5 CFM, greater than or equal to 7 CFM, greater than or equal to 10 CFM, greater than or equal to 12 CFM, or greater than or equal to 14 CFM. In some embodiments, the air permeability of the multi-phase layer (e.g., dual phase layer) is less than or equal to 15 CFM, less than or equal to 12 CFM, less than or equal to 10 CFM, less than or equal to 7 CFM, less than or equal to 5 CFM, less than or equal to 4 CFM, less than or equal to 3 CFM, less than or equal to 2 CFM, less than or equal to 1.9 CFM, less than or equal to 1.8 CFM, less than or equal to 1.7 CFM, less than or equal to 1.6 CFM, less than or equal to 1.5 CFM, less than or equal to 1.25 CFM, less than or equal to 1 CFM, less than or equal to 0.75 CFM, less than or equal to 0.5 CFM, or less than or equal to 0.25 CFM. Combinations of these ranges are also possible (e.g., greater than or equal to 0.1 CFM and less than or equal to 15 CFM, greater than or equal to 0.1 CFM and less than or equal to 2 CFM, greater than or equal to 0.2 CFM and less than or equal to 1.8 CFM, or greater than or equal to 0.5 CFM and less than or equal to 1.5 CFM).

The multi-phase layer (e.g., dual phase layer) may have any suitable mean flow pore size. In some embodiments, the mean flow pore size of the multi-phase layer (e.g., dual phase layer) is greater than or equal to 0.1 microns, greater than or equal to 0.2 microns, greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, or greater than or equal to 2.75 microns. In some embodiments, the mean flow pore size of the multi-phase layer (e.g., dual phase layer) is less than or equal to 3 microns, less than or equal to 2.9 microns, less than or equal to 2.8 microns, less than or equal to 2.7 microns, less than or equal to 2.6 microns, less than or equal to 2.5 microns, less than or equal to 2.4 microns, less than or equal to 2.3 microns, less than or equal to 2.2 microns, less than or equal to 2.1 microns, less than or equal to 2 microns, less than or equal to 1.75 microns, less than or equal to 1.5 microns, less than or equal to 1.25 microns, less than or equal to 1 micron, less than or equal to 0.75 microns, or less than or equal to 0.5 microns. Combinations of these ranges are also possible (e.g., greater than or equal to 0.1 microns and less than or equal to 3 microns, greater than or equal to 0.2 microns and less than or equal to 2.5 microns, or greater than or equal to 0.5 microns and less than or equal to 2 microns).

The multi-phase layer (e.g., dual phase layer) may have any suitable maximum pore size. In some embodiments, the maximum pore size of the multi-phase layer (e.g., dual phase layer) is greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, or greater than or equal to 14 microns. In some embodiments, the maximum pore size of the multi-phase layer (e.g., dual phase layer) is less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, or less than or equal to 6 microns. Combinations of these ranges are also possible (e.g., greater than or equal to 5 microns and less than or equal to 15 microns, greater than or equal to 6 microns and less than or equal to 12 microns, or greater than or equal to 7 microns and less than or equal to 10 microns).

The multi-phase layer (e.g., dual phase layer) may have any suitable dry Mullen burst strength. In some embodiments, the dry Mullen burst strength of the multi-phase layer (e.g., dual phase layer) is greater than or equal to 200 kPa, greater than or equal to 210 kPa, greater than or equal to 220 kPa, greater than or equal to 230 kPa, greater than or equal to 240 kPa, greater than or equal to 250 kPa, greater than or equal to 300 kPa, greater than or equal to 400 kPa, greater than or equal to 500 kPa, greater than or equal to 600 kPa, greater than or equal to 700 kPa, greater than or equal to 800 kPa, greater than or equal to 900 kPa, greater than or equal to 1,000 kPa, greater than or equal to 1,250 kPa, greater than or equal to 1,500 kPa, or greater than or equal to 1,750 kPa. In some embodiments, the dry Mullen burst strength of the multi-phase layer (e.g., dual phase layer) is less than or equal to 2,000 kPa, less than or equal to 1,900 kPa, less than or equal to 1,800 kPa, less than or equal to 1,700 kPa, less than or equal to 1,600 kPa, less than or equal to 1,500 kPa, less than or equal to 1,400 kPa, less than or equal to 1,300 kPa, less than or equal to 1,200 kPa, less than or equal to 1,100 kPa, less than or equal to 1,000 kPa, less than or equal to 900 kPa, less than or equal to 800 kPa, less than or equal to 700 kPa, less than or equal to 600 kPa, less than or equal to 500 kPa, less than or equal to 400 kPa, or less than or equal to 300 kPa. Combinations of these ranges are also possible (e.g., greater than or equal to 200 kPa and less than or equal to 2,000 kPa, greater than or equal to 230 kPa and less than or equal to 1,000 kPa, or greater than or equal to 250 kPa and less than or equal to 800 kPa).

The multi-phase layer (e.g., dual phase layer) may have any suitable dust holding capacity. In some embodiments, the dust holding capacity of the multi-phase layer (e.g., dual phase layer) is greater than or equal to 5 gsm, greater than or equal to 10 gsm, greater than or equal to 20 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 110 gsm, greater than or equal to 120 gsm, greater than or equal to 130 gsm, or greater than or equal to 140 gsm. In some embodiments, the dust holding capacity of the multi-phase layer (e.g., dual phase layer) is less than or equal to 150 gsm, less than or equal to 140 gsm, less than or equal to 130 gsm, less than or equal to 120 gsm, less than or equal to 110 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, less than or equal to 30 gsm, or less than or equal to 20 gsm. Combinations of these ranges are also possible (e.g., greater than or equal to 5 gsm and less than or equal to 150 gsm, greater than or equal to 5 gsm and less than or equal to 100 gsm, or greater than or equal to 5 gsm and less than or equal to 80 gsm). Dust holding capacity may be measured according to ISO 19438 (2003) using ISO medium test dust (A3) and a flow velocity of 0.058 cm/s; dust holding capacity is measured when the pressure drop across the media reaches 100 kPa.

The multi-phase layer (e.g., dual phase layer) may have any suitable initial efficiency. In some embodiments, the initial efficiency at 4 microns for the multi-phase layer (e.g., dual phase layer) is greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, greater than or equal to 99.5%, or greater than or equal to 99.9%. In some embodiments, the initial efficiency at 4 microns for the multi-phase layer (e.g., dual phase layer) is less than or equal to 100%, less than or equal to 99.9%, less than or equal to 99.5%, less than or equal to 99%, less than or equal to 98%, less than or equal to 97%, less than or equal to 96%, less than or equal to 95%, less than or equal to 94%, less than or equal to 93%, or less than or equal to 92%. Combinations of these ranges are also possible (e.g., greater than or equal to 90% and less than or equal to 100%, greater than or equal to 95% and less than or equal to 100%, or greater than or equal to 98% and less than or equal to 100%). Initial efficiency at 4 microns may be measured according to ISO 19438 (2003) using ISO medium test dust (A3), where the initial efficiency at 4 microns is the efficiency at 4 microns measured when the pressure drop reaches 5 kPa (5% of the terminal value of 100 kPa).

The multi-phase layer (e.g., dual phase layer) may have any suitable initial efficiency. In some embodiments, the initial efficiency at 10 microns for the multi-phase layer (e.g., dual phase layer) is greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, greater than or equal to 99.5%, or greater than or equal to 99.9%. In some embodiments, the initial efficiency at 10 microns for the multi-phase layer (e.g., dual phase layer) is less than or equal to 100%, less than or equal to 99.9%, less than or equal to 99.5%, less than or equal to 99%, less than or equal to 98%, less than or equal to 97%, less than or equal to 96%, less than or equal to 95%, less than or equal to 94%, less than or equal to 93%, or less than or equal to 92%. Combinations of these ranges are also possible (e.g., greater than or equal to 90% and less than or equal to 100%, greater than or equal to 95% and less than or equal to 100%, or greater than or equal to 98% and less than or equal to 100%). Initial efficiency at 10 microns may be measured according to ISO 19438 (2003) using ISO medium test dust (A3), where the initial efficiency at 10 microns is the efficiency at 10 microns measured when the pressure drop reaches 5 kPa (5% of the terminal value of 100 kPa).

The multi-phase layer (e.g., dual phase layer) may have any suitable initial efficiency. In some embodiments, the initial efficiency at 20 microns for the multi-phase layer (e.g., dual phase layer) is greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, greater than or equal to 99.5%, or greater than or equal to 99.9%. In some embodiments, the initial efficiency at 20 microns for the multi-phase layer (e.g., dual phase layer) is less than or equal to 100%, less than or equal to 99.9%, less than or equal to 99.5%, less than or equal to 99%, less than or equal to 98%, less than or equal to 97%, less than or equal to 96%, less than or equal to 95%, less than or equal to 94%, less than or equal to 93%, or less than or equal to 92%. Combinations of these ranges are also possible (e.g., greater than or equal to 90% and less than or equal to 100%, greater than or equal to 95% and less than or equal to 100%, or greater than or equal to 98% and less than or equal to 100%). Initial efficiency at 20 microns may be measured according to ISO 19438 (2003) using ISO medium test dust (A3), where the initial efficiency at 20 microns is the efficiency at 20 microns measured when the pressure drop reaches 5 kPa (5% of the terminal value of 100 kPa).

The multi-phase layer (e.g., dual phase layer) may have any suitable initial efficiency. In some embodiments, the initial efficiency at 30 microns for the multi-phase layer (e.g., dual phase layer) is greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, greater than or equal to 99.5%, or greater than or equal to 99.9%. In some embodiments, the initial efficiency at 30 microns for the multi-phase layer (e.g., dual phase layer) is less than or equal to 100%, less than or equal to 99.9%, less than or equal to 99.5%, less than or equal to 99%, less than or equal to 98%, less than or equal to 97%, less than or equal to 96%, less than or equal to 95%, less than or equal to 94%, less than or equal to 93%, or less than or equal to 92%. Combinations of these ranges are also possible (e.g., greater than or equal to 90% and less than or equal to 100%, greater than or equal to 95% and less than or equal to 100%, or greater than or equal to 98% and less than or equal to 100%). Initial efficiency at 30 microns may be measured according to ISO 19438 (2003) using ISO medium test dust (A3), where the initial efficiency at 30 microns is the efficiency at 4 microns measured when the pressure drop reaches 5 kPa (5% of the terminal value of 100 kPa).

In some embodiments, the initial efficiency at 1.5 microns for the multi-phase layer (e.g., dual phase layer) is greater than or equal to 80%, greater than or equal to 82%, greater than or equal to 85%, greater than or equal to 88%, greater than or equal to 90%, greater than or equal to 92%, greater than or equal to 95%, greater than or equal to 97%, greater than or equal to 98%, greater than or equal to 99%, greater than or equal to 99.5%, or greater than or equal to 99.9%. In some embodiments, the initial efficiency at 1.5 microns for the multi-phase layer (e.g., dual phase layer) is less than or equal to 100%, less than or equal to 99.9%, less than or equal to 99.5%, less than or equal to 99%, less than or equal to 98%, less than or equal to 97%, less than or equal to 96%, less than or equal to 95%, less than or equal to 93%, less than or equal to 90%, less than or equal to 88%, or less than or equal to 85%. Combination of these ranges are also possible (e.g., greater than or equal to 80% and less than or equal to 100%, greater than or equal to 90% and less than or equal to 99.9%, or greater than or equal to 95% and less than or equal to 99.5%). Initial efficiency at 1.5 microns may be measured according to a modified version of ISO 19438 (2003) that uses ISO fine test dust instead of ISO medium test dust (A3), that uses light scattering instead of light blocking for the particle count measurement, and where the initial efficiency at 1.5 microns is the efficiency at 1.5 microns measured when the pressure drop reaches 5 kPa (5% of the terminal value of 100 kPa).

In some embodiments, the multi-phase layer (e.g., dual phase layer) (e.g., multi-phase layer 250 (e.g., dual phase layer) of FIG. 2A) is formed at least in part by wet end compression. For instance, in some embodiments, after forming the first phase and second phase by a wet laid process (e.g., after the headbox on a paper machine), the first phase is on top of the second phase, both are still wet, and they are compressed together, drawing water out of them. In some embodiments, the compression is applied with running felt on the top and bottom roll.

In some embodiments, formation of the multi-phase layer (e.g., dual phase layer) with wet end compression results in increased dry Mullen burst strength. For example, in some embodiments, a filter media disclosed herein where the multi-phase layer (e.g., dual phase layer) is formed at least in part by wet end compression has a higher Mullen burst strength than a similar filter media where the multi-phase layer (e.g., dual phase layer) was not formed by wet end compression, all other factors being equal.

Any suitable amount of pressure may be used to compress the first phase to the second phase. The amount of pressure applied may be tailored to achieve desired characteristics of the media. For instance, in some cases, if the amount of pressure used in wet end compression is too low, the efficiency of the multi-phase layer (e.g., dual phase layer) and/or filter media may be reduced, but if the amount of pressure is too high, the dust holding capacity may be reduced.

In some embodiments, the pressure used in a wet end compression process (e.g., to compress the first phase to the second phase) is greater than or equal to 1 bar, greater than or equal to 2 bar, greater than or equal to 3 bar, greater than or equal to 4 bar, greater than or equal to 5 bar, greater than or equal to 10 bar, greater than or equal to 15 bar, greater than or equal to 20 bar, greater than or equal to 25 bar, greater than or equal to 30 bar, greater than or equal to 40 bar, greater than or equal to 50 bar, greater than or equal to 60 bar, greater than or equal to 70 bar, greater than or equal to 80 bar, or greater than or equal to 90 bar. In some embodiments, the pressure used in a wet end compression process (e.g., to compress the first phase to the second phase) is less than or equal to 100 bar, less than or equal to 99 bar, less than or equal to 90 bar, less than or equal to 85 bar, less than or equal to 80 bar, less than or equal to 75 bar, less than or equal to 70 bar, less than or equal to 65 bar, less than or equal to 60 bar, less than or equal to 50 bar, less than or equal to 40 bar, less than or equal to 30 bar, less than or equal to 20 bar, less than or equal to 10 bar, or less than or equal to 5 bar. Combinations of these ranges are also possible (e.g., greater than or equal to 1 bar and less than or equal to 100 bar, greater than or equal to 1 bar and less than or equal to 75 bar, or greater than or equal to 1 bar and less than or equal to 60 bar).

The compression may be applied for any suitable duration of time. In some embodiments, the duration of time is greater than or equal to 0.1 seconds, greater than or equal to 0.5 seconds, greater than or equal to 1 second, greater than or equal to 2 seconds, greater than or equal to 3 seconds, greater than or equal to 4 seconds, greater than or equal to 5 seconds, greater than or equal to 6 seconds, greater than or equal to 7 seconds, greater than or equal to 8 seconds, or greater than or equal to 9 seconds. In some embodiments, the duration of time is less than or equal to 10 seconds, less than or equal to 9 seconds, less than or equal to 8 seconds, less than or equal to 7 seconds, less than or equal to 6 seconds, less than or equal to 5 seconds, less than or equal to 4 seconds, less than or equal to 3 seconds, less than or equal to 2 seconds, less than or equal to 1 seconds, or less than or equal to 0.5 seconds. Combinations of these ranges are also possible (e.g., greater than or equal to 0.1 seconds and less than or equal to 10 seconds, greater than or equal to 0.1 seconds and less than or equal to 8 seconds, or greater than or equal to 0.1 seconds and less than or equal to 5 seconds).

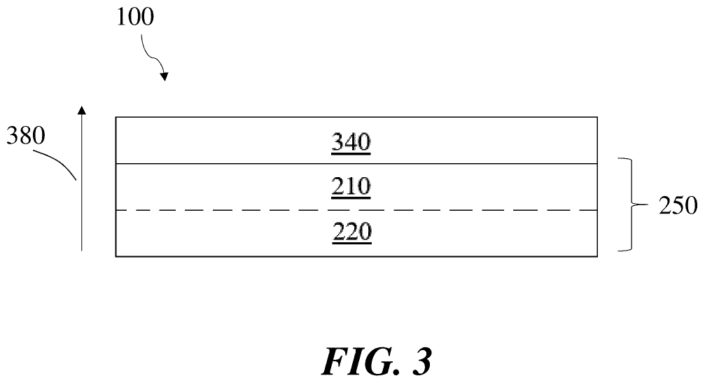

In some embodiments, the filter media comprises one or more layers (e.g., additional layers) in addition to a layer or phase described herein. For example, in some embodiments, a filter media 100 of FIG. 3 comprises an additional layer 340. In some embodiments, the filter media comprises greater than or equal to 1, greater than or equal to 2, or greater than or equal to 3 additional layers. In some embodiments, the filter media comprises less than or equal to 4, less than or equal to 3, less than or equal to 2, or less than or equal to 1 additional layer. In some embodiments, there are no additional layers.

The additional layer may be formed by any suitable process. In some embodiments, the additional layer is formed by a non-wet laid process (e.g., a dry laid process, an air laid process, a spunbond process, or a meltblown process). In some embodiments, the additional layer is formed by laying fibers down on a wire. As used herein, the wire side is the side of the additional layer that was formed against the wire.

In some embodiments, the additional layer and/or the wire side of the additional layer is adjacent to the multi-phase layer (e.g., dual phase layer). For example, as shown illustratively in FIG. 3, additional layer 340 is adjacent to a multi-phase layer 250 (e.g., dual phase layer). In some embodiments, the additional layer and/or the wire side is adjacent to the multi-phase layer (e.g., dual phase layer) with no intervening layers in between. For example, as shown illustratively in FIG. 3, additional layer 340 of FIG. 3 is directly adjacent to multi-phase layer 250 (e.g., dual phase layer) with no intervening layers in between. In some embodiments, the additional layer and/or the wire side of the additional layer is adjacent to the first phase (e.g., with no intervening layers). For example, as shown illustratively in FIG. 3, additional layer 340 is adjacent to a first phase 210 (e.g., with no intervening layers in between). In some embodiments, the additional layer and/or the wire side of the additional layer is adjacent to the second phase (e.g., with no intervening layers in between).

In some embodiments, the additional layer is physically connected to the multi-phase layer (e.g., dual phase layer) and/or the first phase. For example, as shown illustratively in FIG. 3, additional layer 340 of FIG. 3 is physically connected to first phase 210 and multi-phase layer 250 (e.g., dual phase layer), e.g., via an adhesive or via thermal bonding (e.g., thermo-dot bonding). In some embodiments, thermo-dot bonding comprises applying heat and pressure to the additional layer and the multi-phase layer (e.g., dual phase layer) and/or first phase between 2 thermo-dot bonding rollers. It should be appreciated that in some embodiments, the additional layer is connected to the multi-phase layer (e.g., dual phase layer) and/or the first phase by other means without an adhesive or without thermo-dot bonding. For instance, in some instances, the additional layer is collated with the multi-phase layer (e.g., dual phase layer) and/or the first phase.

In some embodiments, thermo-dot bonding the additional layer and the multi-phase layer (e.g., dual phase layer) and/or first phase may have advantages. For example, in some embodiments, thermo-dot bonding the additional layer and the multi-phase layer (e.g., dual phase layer) and/or first phase results in reduced shedding of the fibers (e.g., meltblown fibers) of the additional layer compared to similar layers without thermo-dot bonding, all other factors being equal. In turn, reduced shedding of fibers may result in reduced downtime of the machine (e.g., for cleaning) and/or reduced waste of material. In some embodiments, thermo-dot bonding the additional layer and the multi-phase layer (e.g., dual phase layer) and/or first phase allows bonding without an adhesive, which may be advantageous because adhesives can increase expense and/or adhesives may block pores (which could reduce dust holding capacity).

The z-directional bonding strength between the additional layer and the multi-phase layer (e.g., dual phase layer) and/or the first phase may be any suitable value. For example, in some embodiments, the bonding strength in z-direction 380 between additional layer 340 and first phase 210 and/or multi-phase layer 250 (e.g., dual phase layer) shown in of FIG. 3 may be any suitable value. In some embodiments, the z-directional bonding strength between the additional layer and the multi-phase layer (e.g., dual phase layer) and/or the first phase is greater than or equal to 1 N, greater than or equal to 2 N, greater than or equal to 3 N, greater than or equal to 4 N, greater than or equal to 5 N, greater than or equal to 10 N, greater than or equal to 20 N, greater than or equal to 30 N, greater than or equal to 40 N, greater than or equal to 50 N, greater than or equal to 60 N, greater than or equal to 70 N, greater than or equal to 80 N, or greater than or equal to 90 N. In some embodiments, the z-directional bonding strength between the additional layer and the multi-phase layer (e.g., dual phase layer) and/or the first phase is less than or equal to 100 N, less than or equal to 90 N, less than or equal to 80 N, less than or equal to 70 N, less than or equal to 60 N, less than or equal to 50 N, less than or equal to 40 N, less than or equal to 30 N, less than or equal to 20 N, less than or equal to 10 N, or less than or equal to 5 N. Combinations of these ranges are also possible (e.g., greater than or equal to 1 N and less than or equal to 100 N, greater than or equal to 1 N and less than or equal to 80 N, greater than or equal to 1 N and less than or equal to 60 N). If more than one additional layer is present, the bonding strength in the z-direction between the additional layers and the multi-phase layer (e.g., dual phase layer) and/or the additional layers may each independently have a value in one or more of the above-referenced ranges.

In some embodiments, the z-directional bonding strength (e.g., the z-directional bonding strength that can be achieved with thermo-dot bonding without adhesive) is affected by the percentage of fibrillated fibers in the first phase. For example, in some embodiments, the z-directional bonding strength between the additional layer and the multi-phase layer (e.g., dual phase layer) and/or the first phase after thermo-dot bonding without adhesive is higher for a filter media disclosed herein than for a similar filter media with lower amounts or no fibrillated fibers, all other factors being equal. The z-directional bonding strength may be measured according to DIN 54516:2004-10.

In some embodiments, the additional layer comprises continuous fibers. Examples of continuous fibers include meltblown fibers and/or spunbond fibers. In some embodiments, the additional layer comprises meltblown fibers. In some embodiments, the meltblown fibers comprise one or more polymers. Examples of polymers include polyolefins (e.g., polypropylenes), polyesters (e.g., polybutylene terephthalate, polybutylene naphthalate), polyamides (e.g., nylons), polycarbonates, polyphenylene sulfides, polystyrenes, polyurethanes (e.g., thermoplastic polyurethanes). In some embodiments, the polymer(s) may contain fluorine atoms. Examples of such polymers include PVDF and PTFE. In some embodiments, the meltblown fibers comprise polyamides and/or polybutylene terephthalate.

If continuous fibers (e.g., meltblown fibers) are used, they may have any suitable average diameter. In some embodiments, the average diameter of the continuous fibers (e.g., meltblown fibers) is greater than or equal to 0.5 microns, greater than or equal to 1 micron, greater than or equal to 1.5 microns, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, or greater than or equal to 9 microns. In some embodiments, the average diameter of the continuous fibers (e.g., meltblown fibers) is less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1.5 microns, or less than or equal to 1 micron. Combinations of these ranges are also possible (e.g., greater than or equal to 0.5 microns and less than or equal to 10 microns, greater than or equal to 1.5 microns and less than or equal to 8 microns, or greater than or equal to 1.5 microns and less than or equal to 6 microns).

The continuous fibers (e.g., meltblown fibers) may have any suitable average length. For instance, continuous fibers may have an average length of at least about 5 cm, at least about 10 cm, at least about 15 cm, at least about 20 cm, at least about 50 cm, at least about 100 cm, at least about 200 cm, at least about 500 cm, at least about 700 cm, at least about 1000 cm, at least about 1500 cm, at least about 2000 cm, at least about 2500 cm, at least about 5000 cm, or at least about 10000 cm. Other values of average continuous fiber length are also possible.

Regardless of the type of fibers(s) in the additional layer, the fibers of the additional layer may have any suitable average fiber diameter. In some embodiments, the average fiber diameter of the additional layer is greater than or equal to 0.5 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, or greater than or equal to 9 microns. In some embodiments, the average fiber diameter of the additional layer is less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, or less than or equal to 1 micron. Combinations of these ranges are also possible (e.g., greater than or equal to 0.5 microns and less than or equal to 10 microns, greater than or equal to 0.4 microns and less than or equal to 8 microns, or greater than or equal to 0.5 microns and less than or equal to 6 microns). As described herein, in some embodiments, the additional layer comprises continuous fibers. If more than one additional layer is present, the average fiber diameter of each additional layer may independently have a value in one or more of the above-referenced ranges.

Regardless of the type of fibers(s) is the additional layer, the fibers of the additional layer may have any suitable average fiber length. In some embodiments, the average fiber length of the additional layer is at least about 5 cm, at least about 10 cm, at least about 15 cm, at least about 20 cm, at least about 50 cm, at least about 100 cm, at least about 200 cm, at least about 500 cm, at least about 700 cm, at least about 1000 cm, at least about 1500 cm, at least about 2000 cm, at least about 2500 cm, at least about 5000 cm, or at least about 10000 cm. Other values of average fiber length in the additional layer are also possible.

The additional layer may have any suitable basis weight. In some embodiments, the basis weight of the additional layer is greater than or equal to 10 gsm, greater than or equal to 20 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 125 gsm, greater than or equal to 150 gsm, or greater than or equal to 175 gsm. In some embodiments, the basis weight of the additional layer is less than or equal to 200 gsm, less than or equal to 190 gsm, less than or equal to 180 gsm, less than or equal to 170 gsm, less than or equal to 160 gsm, less than or equal to 150 gsm, less than or equal to 125 gsm, less than or equal to 100 gsm, less than or equal to 75 gsm, less than or equal to 50 gsm, or less than or equal to 25 gsm. Combinations of these ranges are also possible (e.g., greater than or equal to 10 gsm and less than or equal to 200 gsm, greater than or equal to 10 gsm and less than or equal to 180 gsm, or greater than or equal to 10 gsm and less than or equal to 150 gsm). If more than one additional layer is present, the basis weight of each additional layer may independently have a value in one or more of the above-referenced ranges.

The additional layer may have any suitable thickness. In some embodiments, the thickness of the additional layer is greater than or equal to 0.1 millimeters, greater than or equal to 0.2 millimeters, greater than or equal to 0.3 millimeters, greater than or equal to 0.4 millimeters, greater than or equal to 0.5 millimeters, greater than or equal to 0.6 millimeters, greater than or equal to 0.7 millimeters, greater than or equal to 0.8 millimeters, greater than or equal to 0.9 millimeters, greater than or equal to 1 millimeter, greater than or equal to 1.1 millimeters, greater than or equal to 1.2 millimeters, greater than or equal to 1.3 millimeters, greater than or equal to 1.4 millimeters, greater than or equal to 1.5 millimeters, greater than or equal to 1.6 millimeters, greater than or equal to 1.7 millimeters, greater than or equal to 1.8 millimeters, or greater than or equal to 1.9 millimeters. In some embodiments, the thickness of the additional layer is less than or equal to 2 millimeters, less than or equal to 1.9 millimeters, less than or equal to 1.8 millimeters, less than or equal to 1.7 millimeters, less than or equal to 1.6 millimeters, less than or equal to 1.5 millimeters, less than or equal to 1.4 millimeters, less than or equal to 1.3 millimeters, less than or equal to 1.2 millimeters, less than or equal to 1.1 millimeters, less than or equal to 1 millimeter, less than or equal to 0.9 millimeters, less than or equal to 0.8 millimeters, less than or equal to 0.7 millimeters, less than or equal to 0.6 millimeters, less than or equal to 0.5 millimeters, less than or equal to 0.4 millimeters, less than or equal to 0.3 millimeters, or less than or equal to 0.2 millimeters. Combinations of these ranges are also possible (e.g., greater than or equal to 0.1 millimeters and less than or equal to 2 millimeters, greater than or equal to 0.1 millimeters and less than or equal to 1.8 millimeters, or greater than or equal to 0.1 millimeters and less than or equal to 1.5 millimeters). If more than one additional layer is present, the thickness of each additional layer may independently have a value in one or more of the above-referenced ranges.

The additional layer may have any suitable air permeability. In some embodiments, the air permeability of the additional layer is greater than or equal to 1 CFM, greater than or equal to 5 CFM, greater than or equal to 10 CFM, greater than or equal to 20 CFM, greater than or equal to 30 CFM, greater than or equal to 40 CFM, greater than or equal to 50 CFM, greater than or equal to 60 CFM, greater than or equal to 70 CFM, greater than or equal to 80 CFM, greater than or equal to 90 CFM, greater than or equal to 100 CFM, or greater than or equal to 110 CFM. In some embodiments, the air permeability of the additional layer is less than or equal to 120 CFM, less than or equal to 110 CFM, less than or equal to 100 CFM, less than or equal to 90 CFM, less than or equal to 80 CFM, less than or equal to 70 CFM, less than or equal to 60 CFM, less than or equal to 50 CFM, less than or equal to 40 CFM, less than or equal to 30 CFM, or less than or equal to 20 CFM. Combinations of these ranges are also possible (e.g., greater than or equal to 1 CFM and less than or equal to 120 CFM, greater than or equal to 1 CFM and less than or equal to 100 CFM, or greater than or equal to 1 CFM and less than or equal to 80 CFM). If more than one additional layer is present, the air permeability of each additional layer may independently have a value in one or more of the above-referenced ranges.

In some embodiments, the air permeability of the additional layer is greater than the air permeability of the first phase. In some embodiments, the air permeability of the second phase is greater than the air permeability of the first phase. In some embodiments, the air permeability of the additional layer and the air permeability of the second phase are each independently greater than the air permeability of the first phase.

The additional layer may have any suitable mean flow pore size. In some embodiments, the mean flow pore size of the additional layer is greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, or greater than or equal to 19 microns. In some embodiments, the mean flow pore size of the additional layer is less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, or less than or equal to 4 microns. Combinations of these ranges are also possible (e.g., greater than or equal to 3 microns and less than or equal to 20 microns, greater than or equal to 3 microns and less than or equal to 18 microns, or greater than or equal to 3 microns and less than or equal to 15 microns). If more than one additional layer is present, the mean flow pore size of each additional layer may independently have a value in one or more of the above-referenced ranges.

The additional layer may have any suitable maximum pore size. In some embodiments, the maximum pore size of the additional layer is greater than or equal to 10 microns, greater than or equal to 20 microns, greater than or equal to 30 microns, greater than or equal to 40 microns, greater than or equal to 50 microns, greater than or equal to 60 microns, greater than or equal to 70 microns, greater than or equal to 80 microns, or greater than or equal to 90 microns. In some embodiments, the maximum pore size of the additional layer is less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, or less than or equal to 20 microns. Combinations of these ranges are also possible (e.g., greater than or equal to 10 microns and less than or equal to 100 microns, greater than or equal to 10 microns and less than or equal to 80 microns, greater than or equal to 10 microns and less than or equal to 60 microns). If more than one additional layer is present, the maximum pore size of each additional layer may independently have a value in one or more of the above-referenced ranges.

The additional layer may have any suitable dry Mullen burst strength. In some embodiments, the dry Mullen burst strength of the additional layer is greater than or equal to 1 kPa, greater than or equal to 2 kPa, greater than or equal to 3 kPa, greater than or equal to 4 kPa, greater than or equal to 5 kPa, greater than or equal to 10 kPa, greater than or equal to 20 kPa, greater than or equal to 30 kPa, greater than or equal to 40 kPa, greater than or equal to 50 kPa, greater than or equal to 60 kPa, greater than or equal to 70 kPa, greater than or equal to 80 kPa, or greater than or equal to 90 kPa. In some embodiments, the dry Mullen burst strength of the additional layer is less than or equal to 100 kPa, less than or equal to 95 kPa, less than or equal to 90 kPa, less than or equal to 85 kPa, less than or equal to 80 kPa, less than or equal to 70 kPa, less than or equal to 60 kPa, less than or equal to 50 kPa, less than or equal to 40 kPa, less than or equal to 30 kPa, less than or equal to 20 kPa, less than or equal to 10 kPa, or less than or equal to 5 kPa. Combinations of these ranges are also possible (e.g., greater than or equal to 1 kPa and less than or equal to 100 kPa, greater than or equal to 1 kPa and less than or equal to 90 kPa, or greater than or equal to 1 kPa and less than or equal to 80 kPa). If more than one additional layer is present, the dry Mullen burst strength of each additional layer may independently have a value in one or more of the above-referenced ranges.

The additional layer may have any suitable function. In some embodiments, inclusion of the additional layer increases the dust holding capacity of the filter media.

The filter media (which includes all layers present (e.g., multi-phase layer (e.g., dual phase layer), additional layer, etc.)) may have any suitable basis weight. In some embodiments, the basis weight of the filter media is greater than or equal to 100 gsm, greater than or equal to 125 gsm, greater than or equal to 150 gsm, greater than or equal to 200 gsm, greater than or equal to 250 gsm, greater than or equal to 300 gsm, greater than or equal to 400 gsm, greater than or equal to 500 gsm, greater than or equal to 600 gsm, greater than or equal to 700 gsm, greater than or equal to 800 gsm, or greater than or equal to 900 gsm. In some embodiments, the basis weight of the filter media is less than or equal to 1,000 gsm, less than or equal to 950 gsm, less than or equal to 900 gsm, less than or equal to 850 gsm, less than or equal to 800 gsm, less than or equal to 750 gsm, less than or equal to 700 gsm, less than or equal to 650 gsm, less than or equal to 600 gsm, less than or equal to 550 gsm, less than or equal to 500 gsm, less than or equal to 400 gsm, less than or equal to 300 gsm, less than or equal to 200 gsm, or less than or equal to 150 gsm. Combinations of these ranges are also possible (e.g., greater than or equal to 100 gsm and less than or equal to 1,000 gsm, greater than or equal to 100 gsm and less than or equal to 800 gsm, or greater than or equal to 100 gsm and less than or equal to 500 gsm).

The filter media may have any suitable thickness. In some embodiments, the thickness of the filter media is greater than or equal to 0.2 millimeters, greater than or equal to 0.3 millimeters, greater than or equal to 0.4 millimeters, greater than or equal to 0.5 millimeters, greater than or equal to 0.6 millimeters, greater than or equal to 0.7 millimeters, greater than or equal to 0.8 millimeters, greater than or equal to 0.9 millimeters, greater than or equal to 1 millimeter, greater than or equal to 1.5 millimeters, greater than or equal to 2 millimeters, greater than or equal to 3 millimeters, or greater than or equal to 4 millimeters. In some embodiments, the thickness of the filter media is less than or equal to 5 millimeters, less than or equal to 4.5 millimeters, less than or equal to 4 millimeters, less than or equal to 3.5 millimeters, less than or equal to 3 millimeters, less than or equal to 2.5 millimeters, less than or equal to 2 millimeters, less than or equal to 1.5 millimeters, less than or equal to 1 millimeter, less than or equal to 0.9 millimeters, less than or equal to 0.8 millimeters, less than or equal to 0.7 millimeters, less than or equal to 0.6 millimeters, less than or equal to 0.5 millimeters, less than or equal to 0.4 millimeters, or less than or equal to 0.3 millimeters. Combinations of these ranges are also possible (e.g., greater than or equal to 0.2 millimeters and less than or equal to 5 millimeters, greater than or equal to 0.2 millimeters and less than or equal to 4 millimeters, or greater than or equal to 0.2 millimeters and less than or equal to 3 millimeters).

The filter media may have any suitable air permeability. In some embodiments, the air permeability of the filter media is greater than or equal to 1 CFM, greater than or equal to 2 CFM, greater than or equal to 3 CFM, greater than or equal to 4 CFM, greater than or equal to 5 CFM, greater than or equal to 10 CFM, greater than or equal to 15 CFM, greater than or equal to 20 CFM, greater than or equal to 25 CFM, greater than or equal to 30 CFM, or greater than or equal to 40 CFM. In some embodiments, the air permeability of the filter media is less than or equal to 50 CFM, less than or equal to 45 CFM, less than or equal to 40 CFM, less than or equal to 35 CFM, less than or equal to 30 CFM, less than or equal to 25 CFM, less than or equal to 20 CFM, less than or equal to 15 CFM, less than or equal to 10 CFM, or less than or equal to 5 CFM. Combinations of these ranges are also possible (e.g., greater than or equal to 1 CFM and less than or equal to 50 CFM, greater than or equal to 1 CFM and less than or equal to 30 CFM, or greater than or equal to 1 CFM and less than or equal to 5 CFM).

The filter media may have any suitable mean flow pore size. In some embodiments, the mean flow pore size of the filter media is greater than or equal to 0.1 microns, greater than or equal to 0.2 microns, greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 1.25 microns, greater than or equal to 1.5 microns, greater than or equal to 1.75 microns, greater than or equal to 2 microns, greater than or equal to 2.5 microns, greater than or equal to 3 microns, greater than or equal to 4 microns, greater than or equal to 5 microns, greater than or equal to 10 microns, greater than or equal to 15 microns, greater than or equal to 20 microns, or greater than or equal to 25 microns. In some embodiments, the mean flow pore size of the filter media is less than or equal to 30 microns, less than or equal to 25 microns, less than or equal to 20 microns, less than or equal to 15 microns, less than or equal to 10 microns, less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.75 microns, less than or equal to 1.5 microns, less than or equal to 1.25 microns, less than or equal to 1 micron, less than or equal to 0.9 microns, less than or equal to 0.8 microns, less than or equal to 0.7 microns, less than or equal to 0.6 microns, or less than or equal to 0.5 microns. Combinations of these ranges are also possible (e.g., greater than or equal to 0.1 microns and less than or equal to 30 microns, greater than or equal to 0.1 microns and less than or equal to 4 microns, or greater than or equal to 0.1 microns and less than or equal to 3 microns).

The filter media may have any suitable maximum pore size. In some embodiments, the maximum pore size of the filter media is greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, greater than or equal to 19 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, the maximum pore size of the filter media is less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, or less than or equal to 2 microns. Combinations of these ranges are also possible (e.g., greater than or equal to 1 micron and less than or equal to 50 microns, greater than or equal to 1 micron and less than or equal to 15 microns, or greater than or equal to 1 micron and less than or equal to 12 microns).

The filter media may have any suitable efficiency. In some embodiments, the filter media has an initial efficiency at 1.5 microns of greater than or equal to 80%, greater than or equal to 85%, greater than or equal to 90%, greater than or equal to 95%, greater than or equal to 97%, greater than or equal to 98%, greater than or equal to 99%, greater than or equal to 99.5%, greater than or equal to 99.9%, or greater than or equal to 99.99%. In some embodiments, the filter media has an initial efficiency at 1.5 microns of less than or equal to 100%, less than or equal to 99.99%, less than or equal to 99.9%, less than or equal to 99.5%, less than or equal to 99%, less than or equal to 98%, less than or equal to 97%, less than or equal to 95%, less than or equal to 90%, or less than or equal to 85%. Combinations of these ranges are also possible (e.g., greater than or equal to 80% and less than or equal to 100% or greater than or equal to 90% and less than or equal to 100%).

In some embodiments, the filter media has an initial efficiency at 4 microns of greater than or equal to 60%, greater than or equal to 65%, greater than or equal to 70%, greater than or equal to 75%, greater than or equal to 80%, greater than or equal to 85%, greater than or equal to 90%, greater than or equal to 95%, greater than or equal to 97%, greater than or equal to 98%, greater than or equal to 99%, greater than or equal to 99.5%, greater than or equal to 99.9%, or greater than or equal to 99.99%. In some embodiments, the filter media has an initial efficiency at 4 microns of less than or equal to 100%, less than or equal to 99.99%, less than or equal to 99.9%, less than or equal to 99.5%, less than or equal to 99%, less than or equal to 98%, less than or equal to 97%, less than or equal to 95%, less than or equal to 90%, less than or equal to 85%, less than or equal to 80%, less than or equal to 75%, less than or equal to 70%, or less than or equal to 65%. Combinations of these ranges are also possible (e.g., greater than or equal to 60% and less than or equal to 100% or greater than or equal to 80% and less than or equal to 100%).

The filter media may have any suitable dust holding capacity. In some embodiments, the dust holding capacity of the filter media is greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 75 gsm, greater than or equal to 100 gsm, greater than or equal to 150 gsm, greater than or equal to 200 gsm, greater than or equal to 250 gsm, greater than or equal to 300 gsm, or greater than or equal to 400 gsm. In some embodiments, the dust holding capacity of the filter media is less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 75 gsm, or less than or equal to 50 gsm. Combinations of these ranges are also possible (e.g., greater than or equal to 10 gsm and less than or equal to 500 gsm, greater than or equal to 20 gsm and less than or equal to 400 gsm, or greater than or equal to 30 gsm and less than or equal to 300 gsm).

The filter media may have any suitable dry Mullen burst strength. In some embodiments, the dry Mullen burst strength of the filter media is greater than or equal to 10 kPa, greater than or equal to 15 kPa, greater than or equal to 20 kPa, greater than or equal to 25 kPa, greater than or equal to 30 kPa, greater than or equal to 35 kPa, greater than or equal to 40 kPa, greater than or equal to 45 kPa, greater than or equal to 50 kPa, greater than or equal to 60 kPa, greater than or equal to 75 kPa, greater than or equal to 90 kPa, greater than or equal to 100 kPa, greater than or equal to 125 kPa, greater than or equal to 150 kPa, greater than or equal to 200 kPa, greater than or equal to 300 kPa, greater than or equal to 400 kPa, greater than or equal to 500 kPa, greater than or equal to 750 kPa, greater than or equal to 1,000 kPa, greater than or equal to 1,250 kPa, greater than or equal to 1,500 kPa, or greater than or equal to 1,750 kPa. In some embodiments, the dry Mullen burst strength of the filter media is less than or equal to 2,000 kPa, less than or equal to 1,900 kPa, less than or equal to 1,800 kPa, less than or equal to 1,700 kPa, less than or equal to 1,600 kPa, less than or equal to 1,500 kPa, less than or equal to 1,400 kPa, less than or equal to 1,300 kPa, less than or equal to 1,200 kPa, less than or equal to 1,100 kPa, less than or equal to 1,000 kPa, less than or equal to 750 kPa, less than or equal to 500 kPa, less than or equal to 400 kPa, less than or equal to 300 kPa, less than or equal to 200 kPa, less than or equal to 150 kPa, less than or equal to 125 kPa, less than or equal to 100 kPa, less than or equal to 75 kPa, less than or equal to 50 kPa, or less than or equal to 25 kPa. Combinations of these ranges are also possible (e.g., greater than or equal to 10 kPa and less than or equal to 2,000 kPa, greater than or equal to 20 kPa and less than or equal to 1,500 kPa, or greater than or equal to 50 kPa and less than or equal to 1,000 kPa).

In some embodiments, a filter media described herein may be a component of a filter element. That is, the filter media may be incorporated into an article suitable for use by an end user. Non-limiting examples of suitable filter elements include flat panel filters, V-bank filters (comprising, e.g., between 1 and 24 Vs), cartridge filters, cylindrical filters, conical filters, and curvilinear filters. Filter elements may have any suitable height (e.g., between 2 inches and 124 inches for flat panel filters, between 4 inches and 124 inches for V-bank filters, between 1 inch and 124 inches for cartridge and cylindrical filter media). Filter elements may also have any suitable width (between 2 inches and 124 inches for flat panel filters, between 4 inches and 124 inches for V-bank filters). Some filter media (e.g., cartridge filter media, cylindrical filter media) may be characterized by a diameter instead of a width; these filter media may have a diameter of any suitable value (e.g., between 1 inch and 124 inches). Filter elements typically comprise a frame, which may be made of one or more materials such as cardboard, aluminum, steel, alloys, wood, and polymers.

In some embodiments, a filter media described herein may be a component of a filter element and may be pleated. The pleat height and pleat density (number of pleats per unit length of the media) may be selected as desired. In some embodiments, the pleat height may be greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, or less than or equal to 15 mm. Combinations of the above-referenced ranges are also possible (e.g., greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ inch and 24 inches, and/or pleat densities between 1 and 50 pleats/inch. As another example, filter media within cartridge filters or conical filters may have pleat heights between ¼ inch and 24 inches and/or pleat densities between ½ and 100 pleats/inch. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

In one set of embodiments, the filter media described herein is incorporated into a filter element having a cylindrical configuration, which may be suitable for hydraulic and other applications. The cylindrical filter element may include a steel support mesh that can provide pleat support and spacing, and which protects against media damage during handling and/or installation. The steel support mesh may be positioned as an upstream and/or downstream layer. The filter element can also include upstream and/or downstream support layers that can protect the filter media during pressure surges. These layers can be combined with filter media 10, which may include two or more layers as noted above.

In one set of embodiments, a filter media described herein is incorporated into a fuel filter element (e.g., a cylindrical fuel filter element). Fuel filter elements can be of varying types, e.g., fuel filter elements to remove particulates, fuel-water separators to remove water from diesel fuel, and fuel filter elements that perform both particulate separation and water separation. The fuel filter element may be a single stage element or multiple stage element. In some cases, the media can be pleated or wrapped, supported or unsupported, cowrapped/copleated with multiple media. In some designs, the media is pleated with a wrapped core in the center.

In some embodiments, a filter media described herein is incorporated into a fuel-water separator. A fuel-water separator may have a bowl-like design which collects water at the bottom. Depending on the water collection, the water may be collected upstream, downstream, or on both sides of the collection bowl. The water can then be drained off by opening a valve at the bottom of the bowl and letting the water run out, until the bowl contains only fuel/diesel. In some embodiments, the fuel-water separator may include a water sensor to signal the engine control unit, or to signal the driver directly, if the water reaches a warning level. The fuel-water separator may also include a sensor, which can alert the operator when the filter needs to be drained. In some cases, a heater may be positioned near the filter to help avoid the forming of paraffin wax (in case of low temperatures) inside the filter which can stop fuel flow to the engine.

The filter element may also have any suitable dimensions. For example, the filter element may have a length of at least 15 inches, at least 20 inches, at least 25 inches, at least 30 inches, at least 40 inches, or at least 45 inches. The surface area of the filter media may be, for example, at least 220 square inches, at least 230 square inches, at least 250 square inches, at least 270 square inches, at least 290 square inches, at least 310 square inches, at least 330 square inches, at least 350 square inches, or at least 370 square inches.

The filter elements may have the same property values as those noted above in connection with the filter media. For example, the above-noted resistance ratios, basis weight ratios, dust holding capacities, efficiencies, specific capacities, and fiber diameter ratios between various layers of the filter media may also be found in filter elements.

The filter media and/or filter elements described herein may have a variety of suitable uses. In some embodiments, the filter media and/or filter elements described herein may be used for heavy duty air, auto air, gas turbine (both static and pulsing), lube, fuel, hydraulic, coalescer, water, HVAC, and/or HEPA.

The following examples are intended to illustrate some embodiments of the present invention, but do not exemplify the full scope of the invention.

### EXAMPLES

### Example 1: Preparation of Filter Media

This example describes preparation of filter media. The compositions of the prepared filter media are shown in Table 1, where the components of the first phase and second phase are shown prior to the formation of the phases.

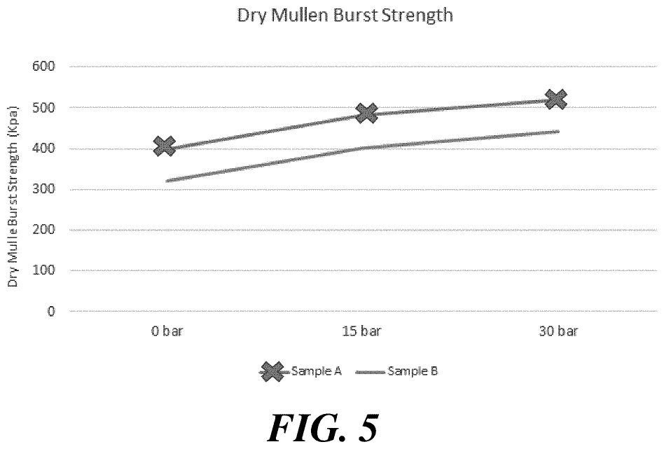

In this example, Samples A-B included a dual phase layer having a first phase and a second phase, which were made using a wetlaid process. The first phase comprised varying amounts of glass fibers (i.e., B04 microglass fibers) and/or fibrillated fibers (i.e., Lyocell fibers). The second phase comprised 100 wt. % cellulose fibers comprising 50 wt. % hardwood fibers and 50 wt. % softwood fibers. The first phase was on top of the second phase and, while both were wet, they were compressed together using a wet end compression process (e.g., by running felt on the top and bottom roll) to form the dual phase layer. Varying pressures were used (as shown in FIG. 5). The pressure was applied for about 1 second. The dual phase layer was dried, and then treated with 18 wt. % resin versus the total weight of the dual phase layer. The dual phase layer with resin was then dried.

In this example, Samples C-E included a dual phase layer having a first and a second phase, which were made using a wetlaid process. The first phase comprised varying amounts of glass fibers (i.e., B04 microglass fibers) and/or fibrillated fibers (i.e., Lyocell fibers). The second phase comprised 100 wt. % cellulose fibers comprising 50 wt. % hardwood fibers and 50 wt. % softwood fibers. The first phase was on top of the second phase and, while both were wet, they were compressed together using a wet end compression process (e.g., by running felt on the top and bottom roll) to form the dual phase layer. 50 bar pressure was applied for about 1 second. The dual phase layer was dried, and then treated with 18 wt. % resin versus the total weight of the dual phase layer. The dual phase layer with resin was then dried. The dual phase layer was then thermo-dot bonded to an additional layer comprising 100 wt. % meltblown fibers (comprising 100 wt. % polybutylentherepthtalate (PBT) fibers), by applying heat and pressure to the additional layer and dual phase layer between 2 thermo-dot bonding rollers, such that the additional layer was physically connected and adjacent to the first phase with no intervening layers.

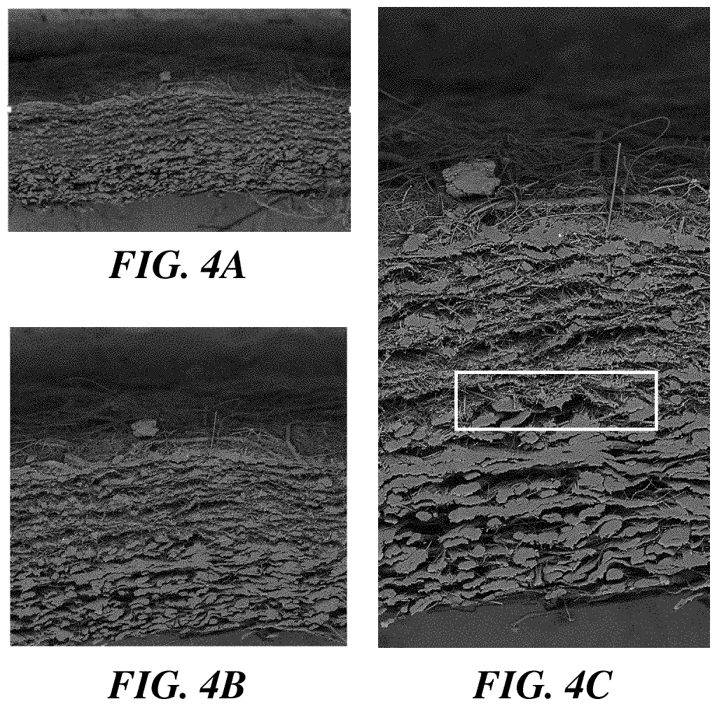

In this example, Sample F (shown in FIG. 4) included a dual phase layer having a first and a second phase, which were made using a wetlaid process. The first phase comprised 50 wt. % glass fibers (i.e., B04 microglass fibers) and 50 wt. % fibrillated fibers (i.e., Lyocell fibers). The second phase comprised 100 wt. % cellulose fibers comprising 50 wt. % hardwood fibers and 50 wt. % softwood fibers. The first phase was on top of the second phase and, while both were wet, they were compressed together using a wet end compression process (e.g., by running felt on the top and bottom roll) to form the dual phase layer. 50 bar pressure was applied for about 1 second. The dual phase layer was then dried.

TABLE 1
Filter Media Compositions

| | Additional | | | | Arrangement |
|---|---|---|---|---|---|
| Sample | Layer | First Phase | Second Phase | Resin | of Layers |
| A | N/A | 100 wt. % (vs. | 100 wt. % | 18 wt. % | First phase |
| | | total fiber | cellulose | resin on dual | directly |
| | | weight) | fibers (50 | phase layer | adjacent to, |
| | | Lyocell fibers | wt. % | versus total | and upstream |
| | | (200 CSF) | hardwood and | weight of | of, the second |
| | | | 50 wt. % | dual phase | phase in the |
| | | | softwood) | layer | dual phase |
| | | | | | layer |
| B | N/A | 67 wt. % (vs. | 100 wt. % | 18 wt. % | First phase |
| | | total fiber | cellulose | resin on dual | directly |
| | | weight) | fibers (50 | phase layer | adjacent to, |
| | | Lyocell fibers | wt. % | versus total | and upstream |
| | | (200 CSF); 33 | hardwood and | weight of | of, the second |
| | | wt.% (vs. total | 50 wt. % | dual phase | phase in the |
| | | fiber weight) | softwood) | layer | dual phase |
| | | B04 | | | layer |
| | | microglass | | | |
| | | fibers | | | |
| C | 100 wt. % | 100 wt. % (vs. | 100 wt. % | 18 wt. % | First phase |
| | meltblown | total fiber | cellulose | resin on dual | directly |
| | fibers (PBT | weight) B04 | fibers (50 | phase layer | adjacent to, |
| | fibers) | microglass | wt. % | versus total | and upstream |
| | | fibers | hardwood and | weight of | of, the second |
| | | | 50 wt. % | dual phase | phase in the |
| | | | softwood) | layer | dual phase |
| | | | | | layer. |
| | | | | | Meltblown |
| | | | | | layer directly |
| | | | | | adjacent to, |
| | | | | | and upstream |
| | | | | | of, the first |
| | | | | | phase/dual |
| | | | | | phase layer. |
| D | 100 wt. % | 50 wt. % (vs. | 100 wt. % | 18 wt. % | First phase |
| | meltblown | total fiber | cellulose | resin on dual | directly |
| | fibers (PBT | weight) | fibers (50 | phase layer | adjacent to, |
| | fibers) | Lyocell fibers | wt. % | versus total | and upstream |
| | | (200 CSF); 50 | hardwood and | weight of | of, the second |
| | | wt. % (vs. total | 50 wt.% | dual phase | phase in the |
| | | fiber weight) | softwood) | layer | dual phase |
| | | B04 | | | layer. |
| | | microglass | | | Meltblown |
| | | fibers | | | layer directly |
| | | | | | adjacent to, |
| | | | | | and upstream |
| | | | | | of, the first |
| | | | | | phase/dual |
| | | | | | phase layer. |
| E | 100 wt. % | 100 wt. % (vs. | 100 wt. % | 18 wt. % | First phase |
| | meltblown | total fiber | cellulose | resin on dual | directly |
| | fibers (PBT | weight) | fibers (50 | phase layer | adjacent to, |
| | fibers) | Lyocell fibers | wt. % | versus total | and upstream |
| | | (200 CSF) | hardwood and | weight of | of, the second |
| | | | 50 wt. % | dual phase | phase in the |
| | | | softwood) | layer | dual phase |
| | | | | | layer. |
| | | | | | Meltblown |
| | | | | | layer directly |
| | | | | | adjacent to, |
| | | | | | and upstream |
| | | | | | of, the first |
| | | | | | phase/dual |
| | | | | | phase layer. |
| F | N/A | 50 wt. % (vs. | 100 wt. % | N/A | First phase |
| | | total fiber | cellulose | | directly |
| | | weight) | fibers (50 | | adjacent to, |
| | | Lyocell fibers | wt. % | | and upstream |
| | | (200 CSF); | hardwood and | | of, the second |
| | | 50 wt. % (vs. | 50 wt. % | | phase in the |
| | | total fiber | softwood) | | dual phase |
| | | weight) B04 | | | layer |
| | | microglass | | | |

### Example 2: Properties of Filter Media

This example describes properties of the filter media described in Example 1.

FIG. 4 is a cross-sectional SEM image of Sample F at 75× magnification (FIG. 4A), 175× magnification (FIG. 4B), and 350× magnification (FIG. 4C). FIG. 4 shows that the dual phase had a gradient in fibers. For example, FIG. 4 shows that the concentration of fibrillated fibers and glass fibers was highest at the outermost surface of the first phase and lowest at the outermost surface of the second phase. Moreover, FIG. 4 shows that there was an intermingling of fibers of the first phase with fibers of the second phase at the interface of the first phase and second phase (as shown in the white box), such that the concentration of fibrillated fibers and glass fibers at the interface was lower than that at the outermost surface of the first phase and higher than that at the outermost surface of the second phase. Further, FIG. 4 demonstrates that the concentration of cellulose fibers was highest at the outermost surface of the second phase, lowest at the outermost surface of the first phase, and in between at the interface of the first phase and second phase.

FIG. 5 is a plot of dry Mullen burst strength of Samples A-B of Example 1 versus the pressure used in the wet end compression process. FIG. 5 demonstrates that the dry Mullen burst strength generally increased with increasing pressure used in the wet end compression process. FIG. 5 also demonstrates that the dry Mullen burst strength generally increased with decreasing percentages of glass fibers and increasing percentages of fibrillated fibers.

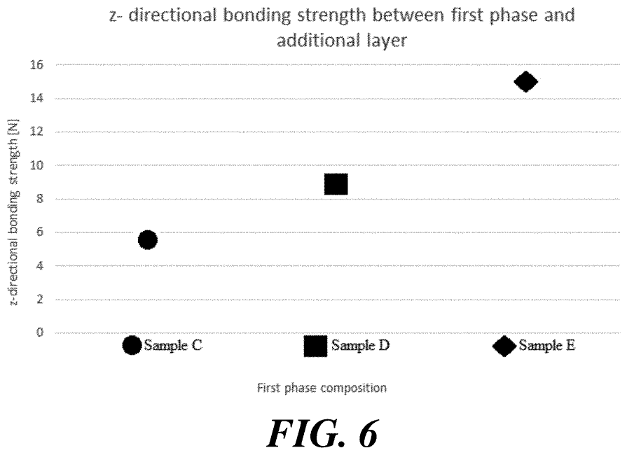

FIG. 6 is a plot of z-directional bonding strength between the first phase and the additional layer of Samples C-E of Example 1. FIG. 6 demonstrates that the z-directional bonding strength generally increased with increasing percentage of fibrillated fibers and decreasing percentage of glass fibers.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A filter media, comprising:
a multi-phase layer,
wherein the multi-phase layer comprises a first phase and a second phase,
wherein the first phase comprises fibrillated fibers and greater than or equal to 25 wt % glass fibers,
wherein the second phase comprises cellulose fibers and/or synthetic fibers,
wherein at least a portion of the fibers of the first phase are intermingled with at least a portion of the fibers of the second phase at an interface of the first phase and the second phase, and
wherein the filter media has a dry Mullen burst strength of greater than 50 kPa and less than or equal to 2,000 kPa.

2. The filter media of claim 1, wherein the first phase comprises greater than or equal to 25 wt % and less than or equal to 80 wt % glass fibers.

3-4. (canceled)

5. A filter media, comprising:
a multi-phase layer comprising a first phase comprising fibrillated fibers and glass fibers and a second phase;
wherein the first phase comprises greater than or equal to 25 wt % and less than or equal to 80 wt % glass fibers; and
wherein the filter media has a dry Mullen burst strength of greater than 50 kPa and less than or equal to 2,000 kPa.

6. A filter media, comprising:
a multi-phase layer comprising a first phase comprising fibrillated fibers and glass fibers and a second phase;
wherein the first phase comprises greater than or equal to 25 wt % and less than or equal to 80 wt % glass fibers; and
wherein the first phase has a dry Mullen burst strength of greater than 50 kPa and less than or equal to 250 kPa.

7-9. (canceled)

10. The filter media of claim 1, wherein the multi-phase layer is a dual phase layer.

11. The filter media of claim 1, wherein the first phase comprises greater than or equal to 30 wt % and less than or equal to 50 wt % glass fibers compared to the total fiber content of the first phase.

12. The filter media of claim 11, wherein the first phase comprises less than 40 wt % glass fibers.

13-16. (canceled)

17. The filter media of claim 1, wherein the first phase comprises greater than or equal to 40 wt % fibrillated fibers and less than or equal to 70 wt % fibrillated fibers compared to the total fiber content of the first phase.

18. The filter media of claim 1, wherein the glass fibers comprise microglass fibers.

19-20. (canceled)

21. The filter media of claim 1, wherein the fibrillated fibers comprise Lyocell fibers.

22-35. (canceled)

36. The filter media of claim 1, wherein the second phase comprises greater than or equal to 70 wt % and less than or equal to 100 wt % cellulose fibers compared to the total fiber content of the second phase.

37-52. (canceled)

53. The filter media of claim 1, wherein the multi-phase layer is formed by a process comprising wet end compression.

54-64. (canceled)

65. The filter media of claim 1, wherein the filter media comprises an additional layer.

66. The filter media of claim 65, wherein the additional layer comprises meltblown fibers.

67-76. (canceled)

77. The filter media of claim 65, wherein the additional layer is bonded to the first phase without an adhesive.

78. The filter media of claim 65, wherein the additional layer is bonded to the first phase without an adhesive with a z-directional bonding strength of greater than or equal to 1 N and less than or equal to 100 N.

79-80. (canceled)

81. The filter media of claim 1, wherein the filter media has an air permeability of greater than or equal to 1 CFM and less than or equal to 50 CFM.

82-83. (canceled)

84. The filter media of claim 1, wherein the filter media has an initial efficiency at 1.5 microns of greater than or equal to 80% and less than or equal to 100%.

85. The filter media of claim 1, wherein the filter media has a dust holding capacity of greater than or equal to 10 gsm and less than or equal to 500 gsm.

86-90. (canceled)
